(19) United States
(12) Patent Application Publication
(10) Pub. No.: US 2012/0057145 A1
(43) Pub. Date: Mar. 8, 2012

(54) SYSTEMS AND METHODS FOR DIAGNOSIS OF EPITHELIAL LESIONS

(76) Inventors: James W. Tunnell, Austin, TX (US); Brandon Nichols, Hutchins, TX (US); Narasimhan Rajaram, Durham, NC (US); Sheldon F. Bish, Austin, TX (US); Liang Lim, Austin, TX (US)

(21) Appl. No.: 13/029,992

(22) Filed: Feb. 17, 2011

Related U.S. Application Data
(63) Continuation-in-part of application No. PCT/US09/54196, filed on Aug. 18, 2009.
(60) Provisional application No. 61/089,736, filed on Aug. 18, 2008.
(60) Provisional application No. 61/323,178, filed on Apr. 12, 2010.

(51) Int. Cl. G01J 3/42; G01N 21/00; G01N 21/55; G01J 3/44

(52) U.S. Cl. 356/51; 356/319; 356/73; 356/445

(57) ABSTRACT

Systems comprising an optical fiber switch connected to a light source and an optical fiber probe, the optical fiber probe comprising a first optical fiber connected to the optical fiber switch and a second optical fiber connected to a spectrophotometer. Methods for determining one or more tissue parameters comprising: emitting light from a first optical fiber into a tissue; collecting the light reemitted from the tissue with a second optical fiber; generating a spectra of the light reemitted from the tissue with a spectrophotometer; and utilizing a look-up table based algorithm to determine one or more tissue parameters, wherein the lookup-table based algorithm comprises the steps of: generating a look-up table by measuring the functional form of a reflectance measured by the spectrophotometer using one or more calibration standards with known optical properties; and implementing an iterative fitting routine based on the lookup-table.

### CROSS-REFERENCE TO RELATED APPLICATIONS

This application is a continuation-in-part of International Application No. PCT/US09/54196, filed Aug. 18, 2009, which claims the benefit of U.S. Provisional Patent Application Ser. No. 61/089,736, filed Aug. 18, 2008; and this application claims the benefit of U.S. Provisional Patent Application Ser. No. 61/323,178, filed Apr. 12, 2010, the entire disclosures of which are hereby incorporated by reference.

### STATEMENT OF GOVERNMENT INTEREST

This invention was made with Government support under Grant Numbers R01CA132032 and R21RR026259 awarded by National Institutes of Health. The Government has certain rights in the invention.

### BACKGROUND

The present disclosure, according to certain embodiments, generally relates to diagnostic systems and methods. In particular, the present disclosure provides, in certain embodiments, systems and methods for diagnosis of epithelial malignancies.

Skin cancer, including both nonmelanoma and melanoma, is the most common malignancy worldwide. As with other epithelial malignancies, early detection and subsequent treatment is paramount to improving prognosis.

The current early detection of skin cancers relies on a critical macroscopic visual analysis of the changes in the cutaneous lesions. Suspected malignancies are excised and analyzed using standard histopathology for diagnosis and treatment decisions.

The most widely used technique to determine whether or not a skin lesion is malignant is a simple biopsy. The problems with this technique are that it is painful and takes five to seven days to receive results. Both pain-free detection and quick results are important to customers. Another problem with this technique is that the decision to biopsy varies greatly with the experience of a dermatologist. Dermatologists are also only likely to biopsy lesions they believe may be malignant and do not have the time to biopsy all skin lesions. Therefore, there is a possibility that malignant skin lesions will go undetected.

Several groups have developed optical probes to detect skin cancers, but these approaches have several limitations. First, diagnostic accuracy for the current clinical examination is inherently qualitative and depends largely on the experience of the physician. It has been shown that general practitioners often have a much lower diagnostic accuracy than expert dermatologist. In addition, access to dermatologists can be limited by geography, financial barriers, and a shortage of supply. Second, the majority of cutaneous melanoma arise in atypical nevi which can easily go unnoticed because they appear as standard moles. In addition, for patients with familial and/or dysplastic nevus syndrome (>100 nevi), it is impossible to excise all suspected dysplastic nevi. Finally, although the sensitivity for the detection of melanoma has been improving (70-90%), the specificity is still quite low, resulting in a large number of unnecessary biopsies which increases costs and morbidity of the procedure. Therefore, a non-invasive method to inspect these lesions would be of great clinical importance.

Currently, when nonmelanoma skin cancers are removed, the surgeon is required to take an excess margin of skin around the lesion to account for nonclinically relevant spread of the tumor. This excess margin can result in a larger scar and greater cosmetic and functional deformity. Noninvasive techniques for limiting the size of these surgical excisions would potentially spare patients from requiring expensive grafting and reconstruction procedures.

### DRAWINGS

The patent or application file contains at least one drawing executed in color. Copies of this patent or patent application publication with color drawing(s) will be provided by the Office upon request and payment of the necessary fee.

Some specific example embodiments of the disclosure may be understood by referring, in part, to the following description and the accompanying drawings.

FIG. 1 shows the spectral diagnosis system used in Examples 1 and 2. L refers to plano-convex lenses; M1—mirror; BS—beam splitter.

FIG. 2 shows the distal end of the fiber probe used in the system shown in FIG. 1. Scale bar is 3 mm.

FIG. 3 shows (a) the white light spectrum from the xenon flash lamp reflecting off of a 20% reflectance standard; and (b) excitation pulses from the nitrogen laser at 337 nm and the dye laser at 445 nm.

FIG. 4 shows (a) the diffuse reflectance spectrum from a tissue phantom (μₛ′(λ₀)=1.35 mm⁻¹ and [Hb]=2 mg/ml) and the LUT-fit; (b) and (c) the optical parameters extracted from the experimental LUT (μₛ′((λ₀)=0.75 mm⁻¹ (∘), 1.35 mm⁻¹ (□) and 1.75 mm⁻¹ (Δ) with 1 μm beads. indicates μₛ′((λ₀)=1 mm⁻¹ with 2 μm beads).

FIG. 5 shows data recorded from tissue phantoms with Stilbene 3 as fluorophore under test. The tissue phantoms contained a fixed scatterer concentration (μs′=1 mm-1) and different concentrations of hemoglobin 0-1.45 mg/ml.

FIG. 6 shows data recorded from tissue phantoms with FAD as fluorophore. FIG. 6(a) shows measured intrinsic fluorescence spectrum of FAD and fluorescence spectra recorded from tissue phantoms with a fixed scatterer concentration (μₛ′=1 mm⁻¹) and different concentrations of hemoglobin 0-1.45 mg/ml. FIG. 6(b) shows diffuse reflectance spectra from each of the tissue phantoms. FIG. 6(c) shows recovery of intrinsic fluorescence spectrum of FAD from a turbid phantom containing 0.82 mg/ml of hemoglobin and comparison with the actual intrinsic fluorescence of the fluorophore. FIG. 6(d) shows a comparison of extracted intrinsic fluorescence spectra for different tissue phantoms.

FIG. 7 shows fluorophore concentrations of (a) Stilbene 3 and (b) FAD extracted using least-squares regression and comparison to actual values. The solid line indicates perfect agreement.

FIG. 8 shows (a) spectrally resolved diffuse reflectance, [R(λ)] (μₛ′(λ)=1.69-3.56 mm⁻¹ and μₐ′(λ)=0-5.33 mm⁻¹) from the calibration set; (b) diffuse reflectance as a sparse matrix mapped to optical property space, [R(μₛ′(λ), μₐ(λ))]; and (c) the resulting lookup table, [R(μₛ′,μₐ)].

FIG. 9 shows a schematic diagram of the LUT inverse model. Fit parameters are μₛ′(λ₀), B, [Hb] and α.

FIG. 10 shows (a) the diffuse reflectance spectrum (μₛ′(λ₀)=2.49 mm⁻¹ and [Hb]=2 mg/ml) and the LUT-fit from a tissue phantom (validation set); (b) and (c) scatter plot of the known versus measured values of μₛ′(λ)(b) and μₐ(λ)(c) for all tissue phantoms. The solid line indicates perfect agreement.

FIG. 11 shows physical parameters extracted from the LUT inverse model (μₛ′(λ₀)=0.91 mm⁻¹ (□), 1.83 mm⁻¹ (∘) and 2.75 mm⁻¹ (⋄)). The solid line indicates perfect agreement.

FIG. 12 shows a non-contact diffuse optical reflectance probe.

FIG. 13 shows the non-contact probe validation. FIG. 13(a) shows the accuracy of hemoglobin concentration extraction. FIG. 13(b) shows the accuracy of reduced scattering coefficient over varying levels of hemoglobin absorption.

FIG. 14(a) shows the non-contact probe depth of field. The beam waist limits the region where extracted reduced scattering accuracy is within low error. FIG. 14(b) shows the reflectance vs. incidence angle for a sample of PDMS with TiO2 scattering agent. Specular reflection causes a sharp increase in signal for incidence angles under 5°.

FIG. 15 shows an example of a typical skin reflectance measurement with the non-contact probe. The spectra is taken from the palm of a subject's hand. The LUT model fit and CCD image of the sampling area are shown. The four red dots on the skin were placed with a marker as a localization reference.

FIG. 16 shows the non-contact reflectance probe ergonomic handpiece prototype.

FIG. 17 shows a schematic for Raman spectroscopy.

FIG. 18 shows a hot mirror wavelength dependent reflection efficiency curve.

FIG. 19 shows a schematic for Raman spectroscopy.

FIG. 20 shows a schematic of an overall system.

FIG. 21 shows a schematic outlining an example of a suitable optical configuration for integration of multiple spectroscopic modalities into a single handheld clinical probe.

While the present disclosure is susceptible to various modifications and alternative forms, specific example embodiments have been shown in the figures and are described in more detail below. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION

The present disclosure, according to certain embodiments, generally relates to diagnostic systems and methods. In particular, the present disclosure provides, in certain embodiments, systems and methods for diagnosis of epithelial malignancies, which may be useful to, among other things, diagnose and/or monitor diseases in a number of clinical situations including, but not limited to, breast cancer, ovarian cancer, Barrett's esophagus, lung cancer, cervical cancer, and skin cancer.

Early detection of melanoma can improve mortality rates, while the early detection of nonmelanoma can improve associated morbidity and cost. For both of these cutaneous malignancies, non-invasive detection strategies will improve mortality, morbidity, and associated costs. Given that skin cancer screening techniques have changed little over the past decade and that the rate of new skin cancer cases is increasing every year, there is certainly a need for a device that can aid dermatologists in accurately and quickly diagnosing skin cancer, particularly melanoma.

In certain embodiments, the present disclosure provides a system comprising an optical fiber switch connected to a light source and an optical fiber probe, the optical fiber probe comprising a first optical fiber connected to the optical fiber switch and a second optical fiber connected to a spectrophotometer.

In certain embodiments, the present disclosure provides a system comprising an optical fiber switch connected to a light source and an optical fiber probe, the optical fiber probe comprising a first optical fiber connected to the optical fiber switch and a second optical fiber connected to a spectrophotometer; and a software interface connected to the spectrophotometer, wherein the software interface is capable of displaying a tissue parameter derived from a spectra generated by the spectrophotometer.

In certain embodiments, the present disclosure provides a method for assessing a tissue comprising: providing an optical fiber switch connected to a light source and an optical fiber probe, the optical fiber probe comprising a first optical fiber connected to the optical fiber switch and a second optical fiber connected to a spectrophotometer; providing a tissue disposed adjacent to the optical fiber probe; allowing light emitted from the first optical fiber into the tissue; collecting the light reemitted from the tissue with the second optical fiber.

In certain embodiments, the present disclosure provides a method for assessing a tissue comprising: providing an optical fiber switch connected to a light source and an optical fiber probe, the optical fiber probe comprising a first optical fiber connected to the optical fiber switch and a second optical fiber connected to a spectrophotometer; providing a software interface connected to the spectrophotometer, wherein the software interface is capable of displaying a tissue parameter derived from a spectra generated by the spectrophotometer; providing a tissue disposed adjacent to the optical fiber probe; allowing light emitted from the first optical fiber into the tissue; collecting the light reemitted from the tissue with the second optical fiber; generating a spectra of the light reemitted from the tissue with a spectrophotometer; and utilizing a look-up table based algorithm to determine one or more tissue parameters.

In certain embodiments, the present disclosure provides a method for determining one or more tissue parameters comprising: emitting light from a first optical fiber into a tissue; collecting the light reemitted from the tissue with a second optical fiber; generating a spectra of the light reemitted from the tissue with a spectrophotometer; and utilizing a look-up table based algorithm to determine one or more tissue parameters, wherein the lookup-table based algorithm comprises the steps of: generating a look-up table by measuring the functional form of a reflectance measured by the spectrophotometer using one or more calibration standards with known optical properties; and implementing an iterative fitting routine based on the lookup-table.

In certain embodiments, the systems of the present invention comprise an optical fiber probe, a spectrophotometer, an optical fiber switch, and a software interface. In certain embodiments, the optical fiber probe may comprise a plurality of optical fibers. In certain embodiments, the optical fiber probe may comprise seven optical fibers. These seven optical fibers may be spatially arranged in any suitable manner. One such arrangement is the “six around one” arrangement, in which six of the seven optical fibers are disposed around the outer diameter of the seventh optical fiber. In certain embodiments, one or more of the optical fibers may emit light, and the remaining fibers may collect the light emitted by one or more fibers.

In certain embodiments, the systems of the present invention further comprise a tissue. The tissue may be any tissue suitable for being analyzed with an optical fiber probe. In certain embodiments, the tissue may be an epithelial tissue, such as, but not limited to, skin, cervical, esophageal, breast, colon, or oral tissue. In certain embodiments, one or more fibers in the optical fiber probe may emit light into the tissue, and the remaining fibers may collect the light reemitted from the tissue.

The light emitted by the optical fiber probe may be one or more a variety of light types. Generally, the light may be any light type suitable for use in analyzing the optical properties of a tissue. Such light types may include, but are not limited to, laser light and white light. Specific examples of light that may be emitted by the optical fiber probe are laser light with a wavelength of about 337 nm, laser light with a wavelength of about 450 nm, and white light emitted from a xenon flashlamp. In certain embodiments, a single type of light may be emitted from a specified optical fiber within the optical fiber probe; thus, multiple fibers may be used to emit multiple light types. In certain embodiments, multiple light types may be emitted by a single optical fiber. In certain embodiments, the “center fiber” in the “six around one” fiber arrangement (i.e. the one fiber around which the other six fibers are disposed) may be the optical fiber probe which emits the one or more light types. In certain embodiments, the remaining optical fibers (such as, but not limited to, the six fibers in the “six around one” fiber arrangement) may collect the light emitted from the single optical fiber.

Generally, light collected by the optical fibers is recorded by the spectrophotometer. Accordingly, any spectrophotometer capable of being operably connect to the optical fiber probes used in the present invention and recording light spectra for the light types used in the present invention may be used. Examples of suitable spectrophotometers include, but are not limited to, imaging spectrographs, grating bases spectrographs, and spectrographs using a CCD. Suitable spectrophotomers are commercially available from, for example, Princeton Instruments, Ocean Optics, Horiba, and Hamamatsu Photonics.

The optical fiber switch may be any optical fiber switch suitable for use with the optical fiber probe and spectrophotometer. The choice of a suitable optical fiber switch may depend upon, among other things, the type, source and/or number of sources of light to be emitted by the one or more optical fiber probes, the spectrophotometer chosen, and the tissue type. An example of an optical fiber switch which may be useful in certain embodiments of the systems and methods of the present invention is a FSM-13 3×1 fiber optic switch, commercially available from Piezosystems Jena, Germany.

In certain embodiments, the software interface may display the light spectra generated by the optical fiber probe. In certain embodiments, such an interface may provide graphical plots for collected light from each light type used. In certain embodiments, the software interface may also a graphical plot of raw sample and calibration spectra taken from one or more calibration standards. In certain embodiments, the spectra generated by the spectrophotometer may be calibrated by the software interface up to or beyond a specified signal to noise ratio. In certain embodiments, such a signal to noise ratio may be about 17 dB. In certain embodiments, this calibration may be performed in a relatively short amount of time. In certain embodiments, the calibration may be performed in approximately one second or less. In certain embodiments, the software interface may determine and display a number of tissue parameters, including, but not limited to, tissue redox ratio, oxygen saturation, scattering parameter, blood concentration, melanin concentration, and collagen content.

In certain embodiments, the systems of the present invention comprise an optical fiber probe comprising a plurality of optical fibers and a fiber tip. The plurality of optical fibers may be arranged and may function as described elsewhere in the present disclosure. The fiber tip, in certain embodiments, may be a detachable article which does not substantially interfere with the emission or collection of light by the optical fiber probe and which provides a sterile point of contact between the optical fiber probe and a subject. In certain embodiments, the fiber tip may be made of a suitable polymeric material, including, but not limited to, polystyrene. In certain embodiments, the fiber tip may be secured to the optical fiber probe via a locking mechanism. Such a locking mechanism, in certain embodiments, may comprise a flexible component on the fiber probe with a male element and a rigid component on the fiber tip with a female element. In such embodiments, the male and female elements may join to secure the fiber tip to the optical fiber probe.

In certain embodiments, the spectra generated by the spectrophotometer may be analyzed by a look-up table (LUT) based algorithm. In certain embodiments, the LUT based algorithm is a LUT-based inverse model that is valid for fiber-based probe geometries with close source-detector separations and tissues with low albedos. In certain embodiments, the LUT inverse model may comprise (1) generating a LUT by measuring the functional form of the reflectance using calibration standards with known optical properties and (2) implementing an iterative fitting routine based on the LUT. In certain embodiments, a nonlinear optimization fitting routine may be used to fit the reflectance spectra. Such a routine may comprise (1) constraining the reduced scattering coefficient to the form μs′(λ)=μs′(λ0).(λ/λ0)−B where λ0=630 nm, (2) calculating an absorption coefficient using the absorption cross-sections σ_{Hb} and σ_{HbO2} as μₐ(λ)=[Hb]*(ασ_{HbO2}+(1−α)σ_{Hb})+X, where α is the oxygen saturation of the tissue, Hb is the total hemoglobin concentration of the tissue, and X is adsorption coefficient of a chromophore (e.g., melanin, beta-carotene, a dye (e.g., indocyanine green)). In certain embodiments, it may be assumed that the absorption in the visible range to be due to oxy- and deoxy-hemoglobin. In certain embodiments, depending on the type of tissue sampled and the wavelength range of interest, the expression for μa(λ) can be modified to include the absorption cross-sections of other absorbing chromophores.

In certain embodiments, the look-up algorithm may be used to determine the tissue parameters displayed by the software interface of the systems of the present invention. For example, in certain embodiments, laser excitation at 337 nm generates fluorescence from the metabolic coenzyme NADH and collagen, while laser excitation at 400 nm generates fluorescence from FAD. Also, in certain embodiments, white light, such as light from xenon flashlamps, may be used to collect elastic scattering spectra. Both NADH and FAD are associated with tissue metabolism and can be used to determine the tissue redox ratio. In certain embodiments, elastic scattering spectra can be fit to a diffusion theory model to extract the blood oxygen saturation, blood concentration, melanin concentration, and tissue scattering parameters.

In certain embodiments, fluorescence spectroscopy may be used to extract biochemical properties. Fluorescence photons are scattered and absorbed during their path to the tissue surface where they are collected via the optical fiber probe. Therefore, the spectral features of the collected fluorescence can be significantly distorted, making the extraction of biochemical composition of the tissue from the measured signal difficult. This is a particular problem in the presence of strong tissue absorbers such as hemoglobin. Intrinsic fluorescence spectroscopy (IFS) is a technique that extracts the fluorescence of the molecules unaffected by the absorption and scattering events from the bulk fluorescence. Because diffuse reflectance undergoes similar absorption and scattering events as fluorescence, information contained within the reflectance spectra can be used to extract the intrinsic fluorescence from the collected fluorescence spectra. Accordingly, in certain embodiments, a LUT-based inverse model may be used to measure the tissue optical properties and correct the acquired fluorescence.

In certain embodiments, Raman spectroscopy may be used to measure the absorption and scattering properties of biological tissues according to the present disclosure. Raman spectroscopy observes the scattering of light by a sample. Monochromatic light of a single frequency must be shone onto a sample in order to have a baseline frequency. This light is usually in the low infrared range. When this light excites a molecule, that molecule exhibits a higher vibrational energy than before. If the molecule returns to its original vibrational energy it will emit a photon that has the same energy and frequency as the excitation photon. This emission is known as Rayleigh scattering. Of the light that is scattered by the sample, about one thousandth of it has a frequency unequal to the excitation frequency. This production of a frequency change is Raman scattering, and it is caused by an energy transfer between the photon and the molecule. Raman scattering produces light with frequencies higher and lower than the excitation frequency. Raman scattered light with a lower frequency than excitation is called Stokes radiation, and it is produced in a much greater quantity than light with a higher frequency. A Raman spectrum can be created from the collected scattered light where Raman bands appear at shifted wavenumbers. The intensity of Raman scattered light and thus the amplitude of the Raman bands are proportional to the number of molecules that are illuminated. Most molecules have a unique fingerprint, meaning they produce characteristic Raman bands. These unique fingerprints enable the detection and quantification of specific molecules in unknown samples. Since cancerous tissues are known to have different molecular concentrations than normal tissue, taking the Raman spectra of a lesion can determine whether or not a lesion is cancerous with great accuracy. In certain embodiments, a LUT-based inverse model may be used with Raman spectroscopy to measure the vibrational modes of biomolecules, such as, for example, collagen, nuclei, lipids, tyrosine, phosphorylation, and C—H bonds.

In certain embodiments using Raman spectroscopy, a 808 nm diode laser and a system of optics may be used to collect Raman spectra, or the Stokes shift that results from molecules indicative of carcinoma. In one embodiment, excitation wavelengths from the laser source will pass through a hot dichroic mirror sandwiched between two achromatic lenses and into the skin. The stokes Raman scattering generated in the skin will then travel back through one of the lens and reflect off the hot dichroic mirror, which must reflect all wavelengths between 830 nm and 1100 nm, through a long pass filter, an achromatic lens, and into a multimodal optic fiber bundle directed to a cryogenically cooled CCD for Raman detection.

In certain embodiments, diffuse optical spectroscopy (DOS) may be used to measure the absorption and scattering properties of biological tissues according to the present disclosure.

The instrumentation for DOS typically uses a combination of optical fiber probes to deliver and collect light from the tissue surface. The application of a standard optical fiber probe requires applied pressure in order to make contact with the tissue, which has been shown to introduce errors in the extracted optical properties. In addition, the distal end of a contact probe can obscure the exact measurement location on the tissue surface.

Accordingly, in one embodiment, the present disclosure provides a handheld non-contact diffuse optical spectroscopy device that removes the effects of probe pressure and documents the measurement site. In one embodiment, the distal end of a standard contact fiber probe is imaged onto the tissue surface and incorporates a CCD camera to acquire a digital picture of the sample area. To mitigate the effects of specular reflection and/or limit depth of focus, a cross polarization and/or an autofocus mechanism may be used, respectively.

In one embodiment, the present disclosure provides a probe with an optical device that images the illumination and collection fibers onto the skin surface, eliminating the influence of contact probe pressure on the sampling area. The non-contact probe addition addresses new optical conditions that may affect its performance such as tissue surface contour, and specular reflections by implementing an auto-focusing mechanism and cross polarization. Extracted optical properties of tissue simulating phantoms yield errors of 3.46% in reduced scattering and 8.62% in absorbance. Auto-focusing has extended the depth of field from 4 mm to throughout the 12 mm range of auto-focus travel, while cross-polarization has removed the incidence angle dependent specular reflection component from the collected signal. The optical device may comprise an optical relay system.

In one embodiment, the distal end of a standard contact fiber probe may be imaged onto the tissue surface. In certain embodiments, the distal end of the contact probe may be imaged onto the sample surface for a 1-to-1 magnification using two 1″ diameter achromatic 100 mm lenses (Thorlabs, Newton, N.J.) in infinite conjugate formation. This optical system maintains the probe geometry for excitation and collection of light. In certain embodiments, the lenses and probe may be mechanically stabilized with a 30 mm cage assembly.

In certain embodiments, reflectance and fluorescence spectroscopy systems may incorporated into the same system and/or used together. In some embodiments, the reflectance and fluorescence spectroscopy systems will work similarly. For example, the excitation wavelengths from the source will pass through a polarizing filter and a polarizing beam splitter sandwiched between two achromatic lenses. The emitted wavelengths will then pass through one lens and onto the polarizing beam splitter, which will only reflect polarized waves. These wavelengths will then pass through another achromatic lens and into a multimodal optic fiber bundle for detection. Such combined reflectance and fluorescence spectroscopy systems may be scaled down and integrated into a handheld device. For example, a combined system may be integrated into a handheld probe by internally rotating the two systems along the vertical axis using a revolving motor so that either modality can be utilized when needed. For this to be practical, the need to maintain alignment of the optical configuration and the window into the skin is important so that the optical pathway remains constant throughout all measurements.

In one embodiment, the present disclosure provides a non-contact handheld probe device that is capable of capturing digital images of skin lesions while also measuring Raman, reflectance and/or fluorescence spectra for the diagnosis of skin cancer.

Therefore, the present invention is well adapted to attain the ends and advantages mentioned as well as those that are inherent therein. While numerous changes may be made by those skilled in the art, such changes are encompassed within the spirit of this invention as illustrated, in part, by the appended claims.

### EXAMPLES

### Example 1

System Description

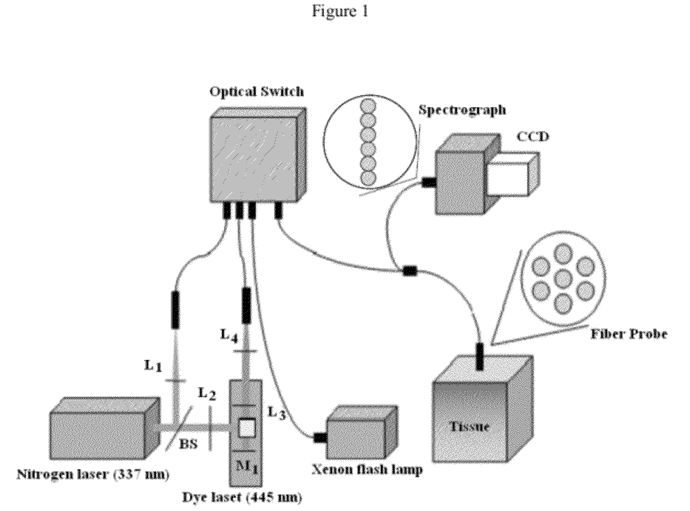

A representation of the spectral diagnosis system used in this example is shown in FIG. 1. Three light sources were used: 1) a pulsed xenon flashlamp (L7684, Hamamatsu Photonics, Bridgewater, N.J.) to collect white light reflectance; 2) a pulsed nitrogen laser (NL-100, Stanford Research Systems, Mountain View, Calif.) at 337 nm and 3) a nitrogen-pumped dye laser at 450 nm. Coumarin 450 (Exciton Inc., Dayton, Ohio) was used as the gain medium for the dye laser. A long pass filter (340 nm; Asahi Spectra, Torrance, Calif.) was placed in the optical path of the xenon flash lamp to minimize exposure to UV light. The specifications for each light source are listed in Table 1. The energy/pulse noted for each light source was the energy measured at the distal end of the output fiber.

TABLE 1

| | | | |
|---|---|---|---|
| Parameter | Xenon flash lamp | Nitrogen Laser | Dye laser |

| | | | | | | |
|---|---|---|---|---|---|---|
| Energy/pulse | 2.5 | μJ | 2.1 | μJ | 4.7 | μJ |
| Operating | 350-700 | nm | 337 | nm | 445 | nm |
| wavelength | | | | | | |

| | | | | | |
|---|---|---|---|---|---|
| FWHM | — | 6 | nm | 6 | nm |

| | | | | | |
|---|---|---|---|---|---|
| Pulse width | 2.90 | μs | 3.5 | ns | N/A |

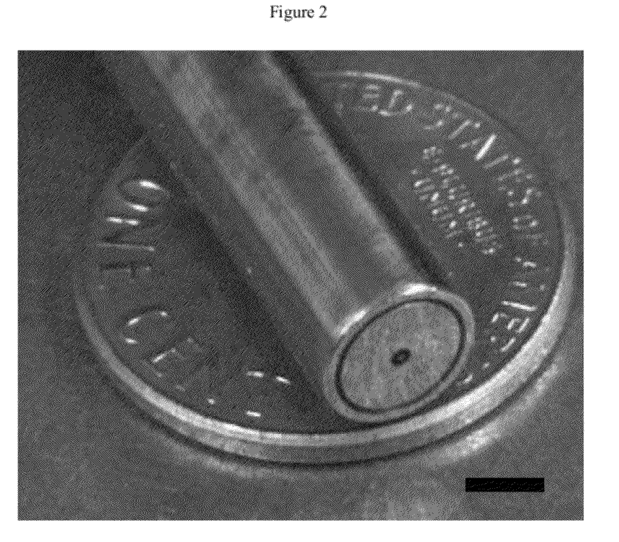

The white light and laser pulses are coupled into optical fibers and guided into a 3×1 fiber optic switch (FSM-13, Piezosystems Jena, Germany). The switch controls the excitation sequence and is triggered by TTL signals. The switch's output fiber is mated with the input fiber of the fiber optic probe. The distal end of the 2 m long bifurcated fiber optic probe (FiberTech Optica, Ontario, Canada) consists of 7 optical fibers arranged in a 6-around-1 configuration (FIG. 2b). The central fiber (NA=0.22, 200 μm core diameter) is used for delivering the light to the skin while the six surrounding fibers (NA=0.22, 200 μm core diameter) collect the remitted light. Because detection of early cancer lesions which originate in the epithelium is of interest in this example, a source-detector separation of 300 μm was chosen. This distance allowed sampling the skin superficially. The six collection fibers were arranged in a linear configuration and aligned parallel to the entrance slit of the spectrograph (SP-150, Princeton Instruments, Trenton, N.J.).

The spectrograph contained a 150 g/mm grating blazed at 500 nm which disperses the collected light onto a cooled CCD (Photometrics, Tucson, Ariz.). The CCD was cooled to a temperature of −30° C. to minimize dark current. The CCD was gated (50 μs), to acquire data only during an excitation pulse. This enabled leaving the room lights on, making the system more clinically compatible. White light reflectance was recorded in the spectral range of 350-700 nm. Binning was performed in a specific region along the slit axis corresponding to probe illumination and in groups of 3 pixels along the wavelength axis to increase the signal to noise ratio. An average over three acquisitions was taken for each light source to further improve the SNR.

Instrument control and spectral calibration was automated using a personal computer running LABVIEW (National Instruments, Austin, Tex.) and MATLAB (Mathworks, Natick, Mass.). A timer/counter board (NI 2121, National Instruments) was used that interfaces with the computer to generate trigger pulses for the light sources, fiber optic switch and the spectrograph. The light sources are triggered in a sequence and the corresponding channels on the fiber optic switch are opened to allow for excitation.

The entire system was built on an optical breadboard and transferred to a portable rack (2′×2′×3′; PTRK-1426, Middle Atlantic Products) (FIG. 2a). The rack houses the power supplies for all the system components as well as a personal computer. Adequate arrangements were made to ensure the proper ventilation of the rack and transfer of heat generated by the power supplies to the outside.

System Calibration

A number of routines were employed to correct for system response and variations in source excitation intensity. The wavelength scale of the CCD is calibrated with a standard mercury-argon (HgAr) lamp.

A background spectrum was recorded with the light sources turned off and subtracted from every reflectance spectrum. This eliminated the effects of CCD dark current and ambient light. In addition, white light reflectance from a 20% reflectance standard (Labsphere, North Sutton, N.H.) was recorded before the start of any measurement cycle. The background-corrected reflectance spectrum was then divided by the standard reflectance to obtain a relative diffuse reflectance measurement. To correct for variations in the white light intensity of the xenon flash lamp, the reflectance from a standard solution of polystyrene microspheres in water (0.12%; Polysciences, Warrington, Pa.) was measured. Diffuse reflectance spectra measured from phantoms are normalized with respect to standard solution of microspheres. The fluorescence spectra are corrected for the spectral response of the system using a NIST traceable tungsten calibration standard (LS-1-CAL, Ocean Optics, Dunedin, Fla.). The fluorescence from a Rhodamine B solution in water (0.01 g/l) was measured to calibrate both the nitrogen and the dye laser for variations in intensity.

Physical Tissue Model

To test the ability of the system to collect reflectance and fluorescence spectra and recover various optical parameters, measurements were made on a matrix of tissue-simulating phantoms. The phantoms were laced in cylindrical vials (20 mm diameter by 15 mm depth) that were large enough to simulate semi-infinite media. The optical fiber probe was placed in contact with the phantom surface to collect diffuse reflectance and fluorescence spectra.

Diffuse Reflectance Phantoms

Tissue phantoms were fabricated using polystyrene microspheres (diameter=1 or 2 μm; Polysciences, Warrington, Pa.) and ferrous stabilized hemoglobin powder (Sigma, St. Louis, Mo.) dissolved in water to simulate scattering and absorption, respectively. Mie theory was used to calculate the reduced scattering coefficients (μₛ′) of the tissue phantoms, and we measured the absorption coefficient (μₐ) of the stock Hb solution using a spectrophotometer (DU 720, Beckman Coulter, Fullerton, Calif.). An array of tissue phantoms were created with varying scattering (μₛ′(λ₀=630 nm)=0.25-3 mm⁻¹) and absorption parameters ([Hb]=0-5 mg/ml).

Intrinsic Fluorescence Phantoms

Commercially available fluorophores were used to prepare tissue phantoms for measuring fluorescence. FAD (Sigma, St. Louis, Mo.) was available commercially and hence was used as the fluorophore under test with the dye laser (445 nm excitation). Stilbene 3 (Exciton, Dayton, Ohio) was chosen to simulate NADH fluorescence due to the similar position of its peak emission wavelength. The tissue phantoms were fabricated in three stages. Non-scattering solutions of the two fluorophores were first prepared to measure the intrinsic fluorescence. The fluorophore concentrations were selected so that the solutions were optically dilute. 0.64 μM of Stilbene 3 and 42.1 μM of FAD were used in the experiments. To examine the combined effect of scattering and absorption, hemoglobin was added in concentrations ranging from 0-1.45 mg/ml. A fixed concentration of beads (μₛ′(μₛ′(λ0)=1 mm⁻¹) was added to simulate scattering.

LUT Inverse Model

Many current strategies for analyzing diffuse reflectance rely on the solution to the diffusion approximation of the radiative transport equation (1), or a modified form (2). However, the diffusion approximation is not valid at source-detector separations less than approximately one mean free path (1/(μₛ′+μₐ)) and in tissues with low albedo (μₛ′/(μₛ′+μₐ)). In addition, many inverse solutions employing the diffusion approximation are computationally intensive. Several probe based systems for sampling shallow tissue depths have recently been proposed (3,4). In addition, Mirabal et al. have shown that short source detector separations provide a higher diagnostic power compared to longer source-detector separations (5). Unfortunately, the diffusion approximation based inverse models are not accurate in many of these regimes. To overcome this limitation, several recent models based on Monte Carlo (6) or higher order approximations to radiative transport (7) have been proposed.

In order to fit the diffuse reflectance spectra generated in this example, a LUT-based inverse model was developed that is valid for fiber-based probe geometries with close source-detector separations and tissues with low albedos. The development of the LUT inverse model followed two steps. First, a LUT is generated by measuring the functional form of the reflectance using calibration standards with known optical properties. Second, an iterative fitting routine is implemented based on the LUT. This LUT was subsequently used in an iterative formulation of the inverse model. We used tissue phantoms to validate the accuracy of the LUT inverse model and consequently the system. A subset of tissue phantoms was used to create the LUT. No test samples used to validate the system had the same optical properties of the phantoms used to create the LUT.

A nonlinear optimization fitting routine was implemented to fit the reflectance spectra. The reduced scattering coefficient was constrained to the form μₛ′(λ)=μₛ′(λ₀).(λ/λ₀)^{-B} where λ₀=630 nm. The absorption in the visible range was assumed to be due to oxy- and deoxy-hemoglobin. The absorption coefficient was calculated using the absorption cross-sections (σ_{Hb} and σ_{HbO2}) of these chromophores as μₛ(λ)=[Hb]*(ασ_{HbO2}+(1−α)σ_{Hb}), where α is the oxygen saturation and [Hb] is the total hemoglobin concentration. Depending on the type of tissue sampled and the wavelength range of interest, the expression for μₛ(λ) can be modified to include the absorption cross-sections of other absorbing chromophores.

System Performance—Signal to Noise Ratio

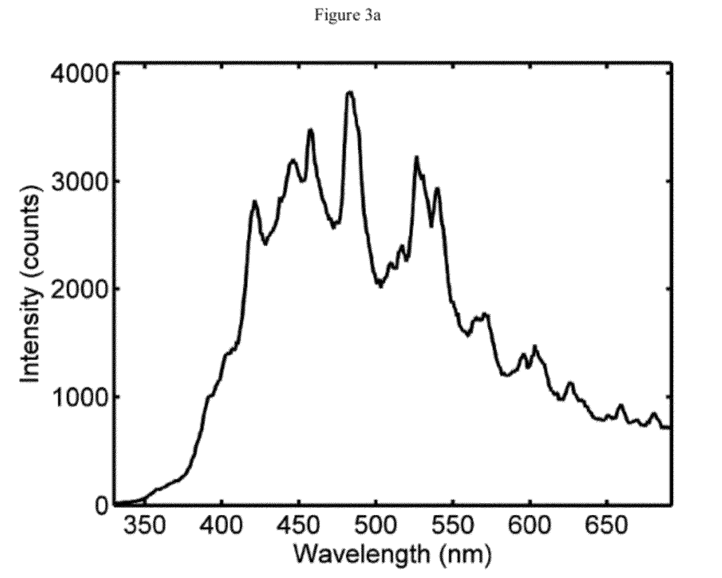

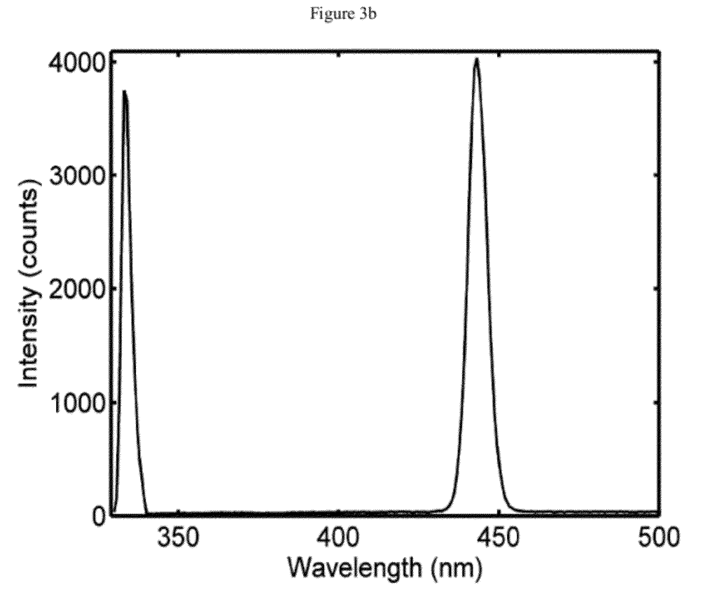

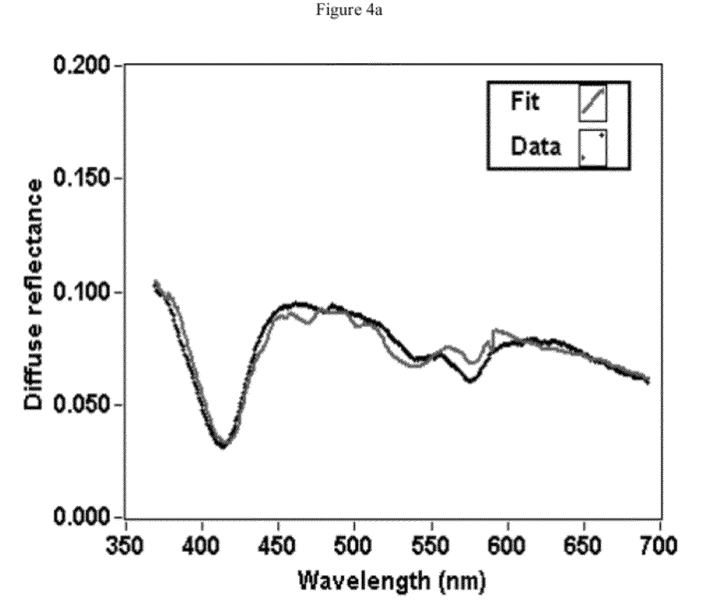

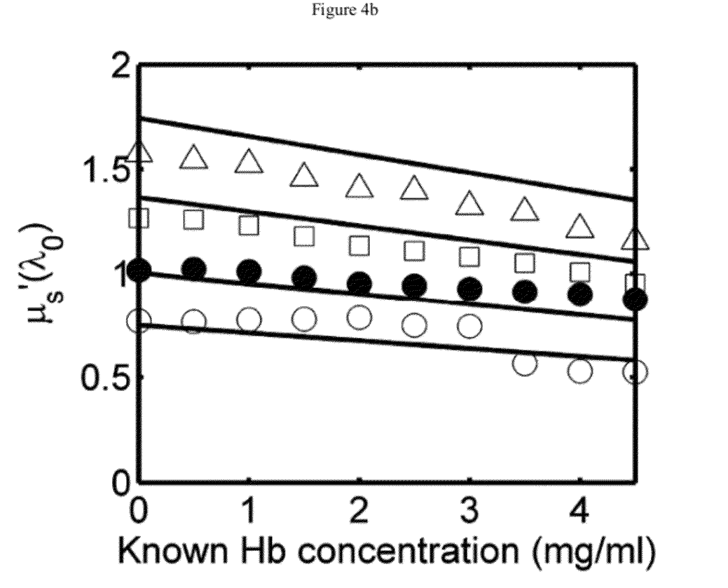

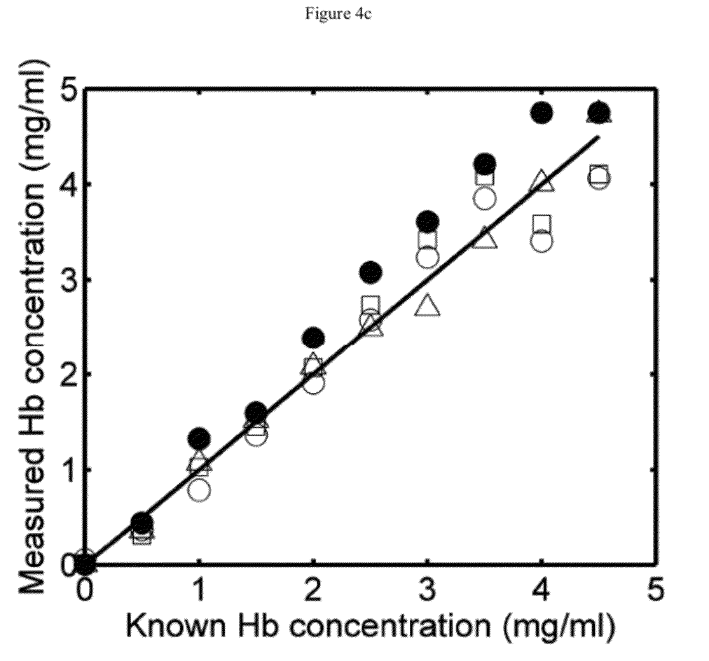

A typical white light spectrum reflecting off of a 20% reflectance standard is shown in FIG. 3. The signal to noise ratio of a typical reflectance spectrum (FIG. 4a) is ˜34 dB. Also shown are laser excitation pulses from the nitrogen laser at 337 nm and the dye laser at 445 nm. The fluorescence spectra from both lasers also show excellent signal to noise (˜40 dB).

System Performance—Diffuse Reflectance

The diffuse reflectance spectrum from a tissue phantom and its corresponding fit is plotted in FIG. 4. The general shape of the curve is derived from the negative power law nature of μₛ′ and depressions due to the characteristic absorption peaks of hemoglobin at 420, 542 and 577 nm. These depressions are quite prominent and become more pronounced as the hemoglobin concentration increases.

FIG. 4 illustrates the results of fitting the measured spectra for the same phantom to the model. Each panel represents a particular optical property recovered. The LUT inverse model estimated the reduced scattering and absorption coefficients over a wide range (μₛ′(λ)=0.56-3.36 mm⁻¹ and μₐ(λ)=0-5.42 mm⁻¹) with mean RMS errors of 9.8% and 11.8% respectively (data not shown). FIG. 4 illustrates extracted physical parameters for each test tissue phantom, demonstrating good agreement between the expected and the measured values of μₛ′(λ₀) and [Hb]. In all phantoms, the oxygen saturation was held a constant and did not vary by more than 2%. The average error in estimating the physical parameters was less than 10%.

System Performance—Intrinsic Fluorescence

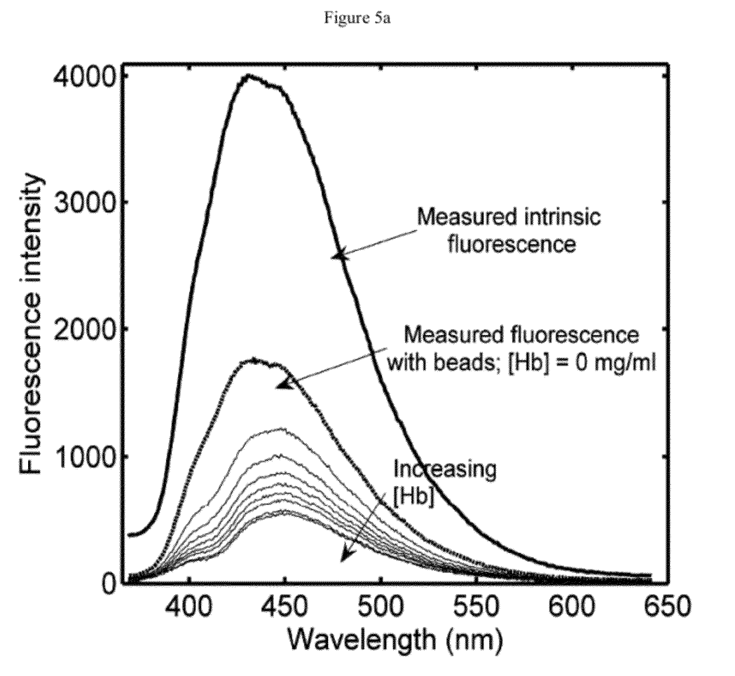

FIG. 5 shows the results of fluorescence measurements on tissue-simulating phantoms with both scattering and absorption (hereafter referred to as turbid phantom). Fluorescence spectra from tissue phantoms with varying concentrations of hemoglobin were plotted and compared to the intrinsic fluorescence spectrum of Stilbene 3 (FIG. 5a). The addition of hemoglobin introduces a distortion in the fluorescence spectrum around 420 nm. This can be attributed to absorption by hemoglobin in the Soret band. This is evident in the diffuse reflectance spectra for the same set of tissue phantoms which show a large depression in the Soret absorption band (FIG. 5b). The intrinsic fluorescence was extracted using a photon migration model described by Mueller et al. (FIG. 5c) (8). There is excellent agreement between the extracted and measured intrinsic fluorescence spectra (FIG. 5d). We were able to recover the intensity and the line shape of the intrinsic fluorescence spectrum with an RMS error of less than 10%.

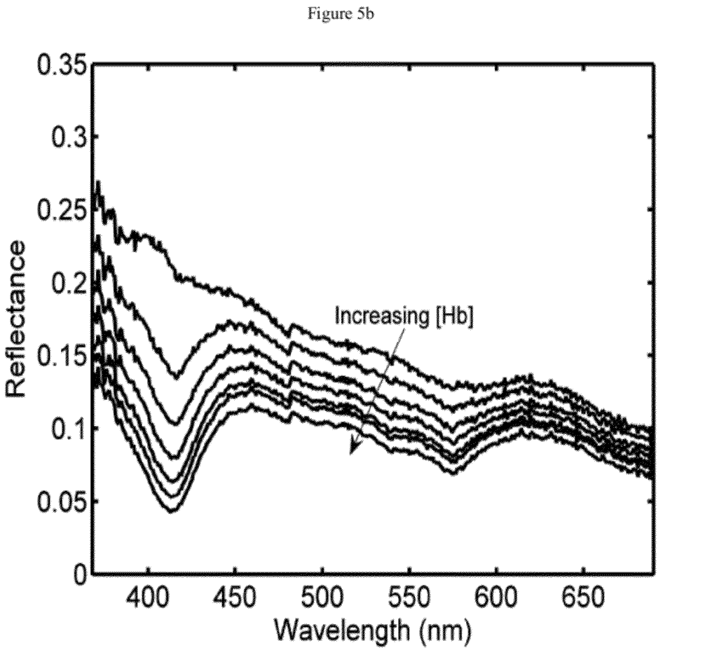

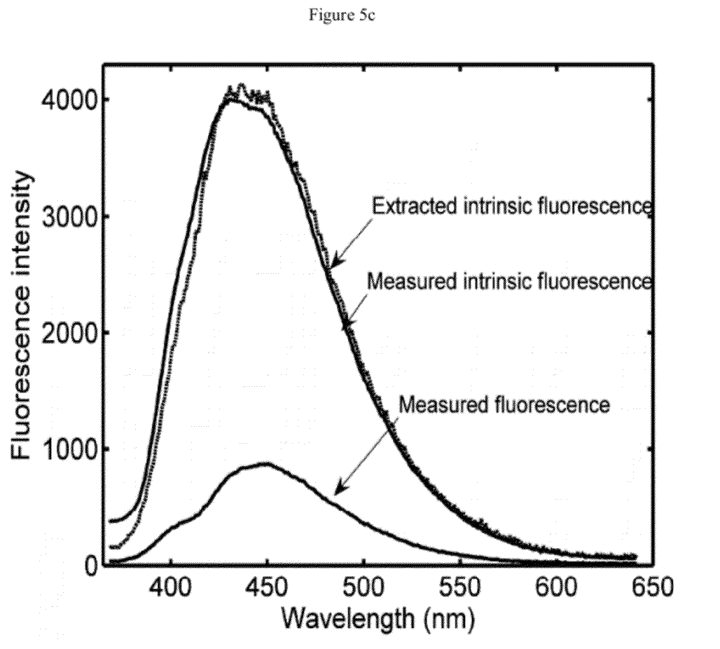

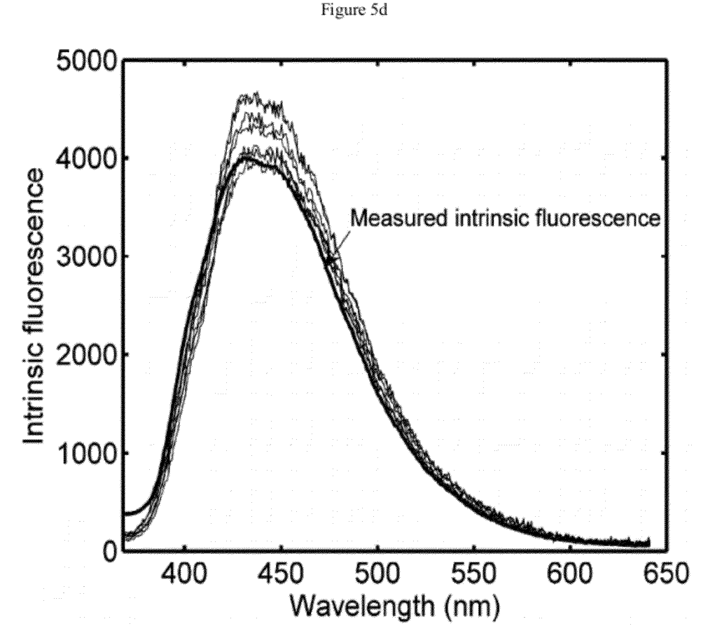

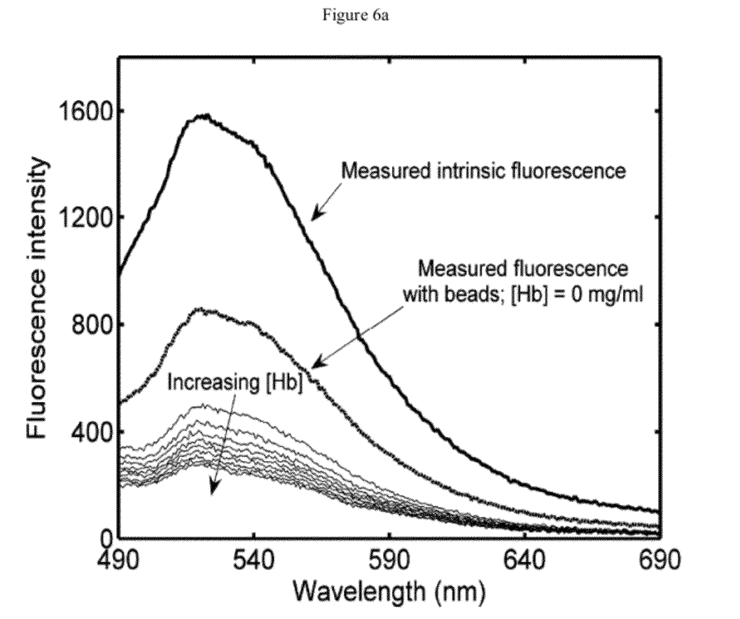

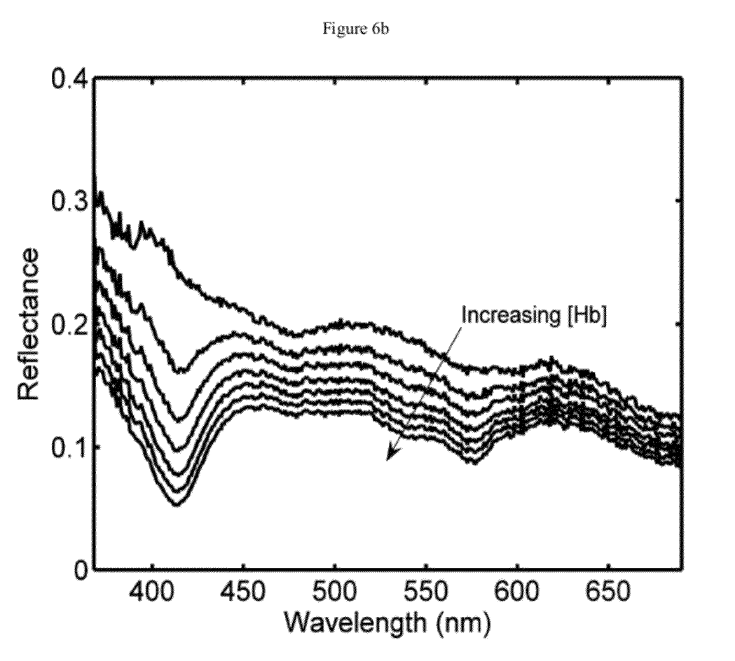

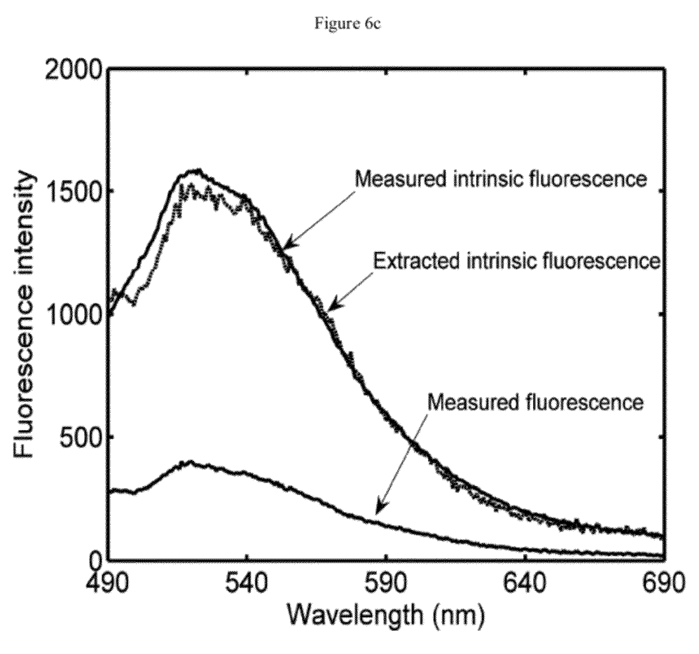

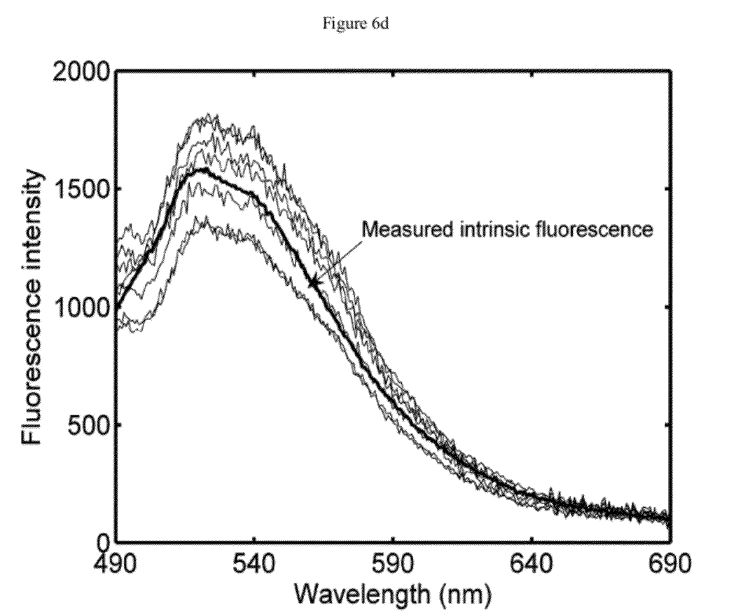

FIG. 6 demonstrates the results of fluorescence measurements on turbid phantoms with FAD as the fluorophore. Although the fluorescence spectrum of FAD is distorted by hemoglobin absorption, the effect is not as prominent as that for 337 nm excitation (FIG. 5a). This is probably because FAD emits in the Q-bands of hemoglobin where the absorption is not as high as in the Soret band (FIG. 5b). This is seen in the corresponding diffuse reflectance spectra of these phantoms (FIG. 5b) which show a relatively small depression in the Q-bands due to hemoglobin absorption. However, there was still a significant correction introduced in the measured fluorescence spectrum of FAD (FIG. 5c). As with Stilbene 3, there was good agreement between the measured and extracted intrinsic fluorescence (RMS error less than 10%) (FIG. 4d).

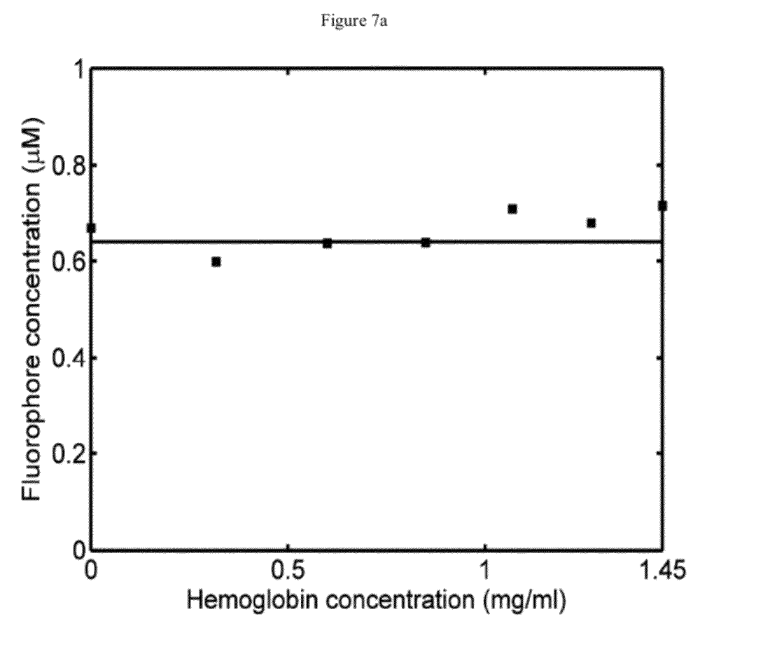

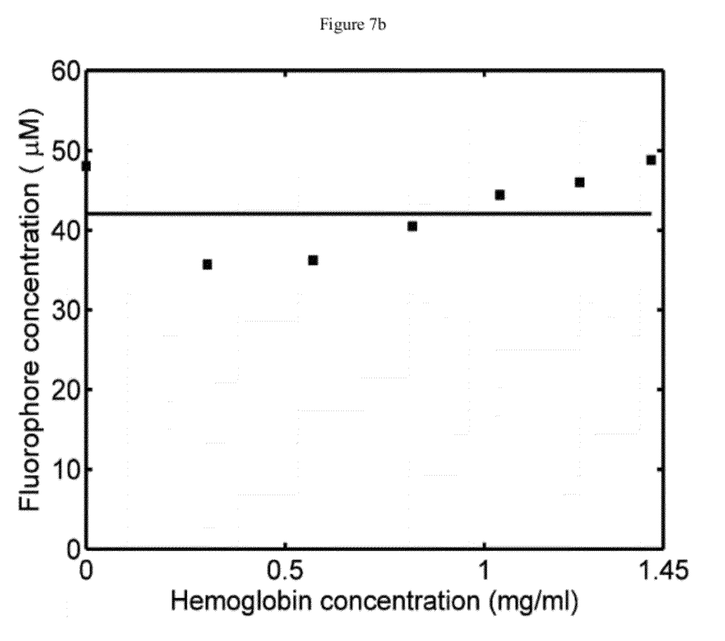

The concentrations of the two fluorophores were extracted with a least-squares regression technique using the following equation (9)

$${χ}^{2} = {\sum }_{{λ}_{1}}^{{λ}_{2}} {[ β ( {λ}_{i} ) - \frac{C}{{C}_{dil}} {β}_{dil} ( {λ}_{i} ) ]}^{2}$$

where β refers to intrinsic fluorescence from a turbid phantom and β_{dil}, the intrinsic fluorescence from an optically dilute solution of the fluorophore. The concentration of the phantom C was the free parameter that was extracted. FIG. 7 shows a comparison of the actual and recovered values of the fluorophore concentrations. The average errors in estimating the concentrations of Stilbene 3 and FAD were 5.87% and 11.1%, respectively.

### Example 2

The system we used to collect the diffuse reflectance is described in detail in Example 1. Briefly, a custom built clinical spectrometer system was used to collect steady state, spectrally resolved diffuse reflectance in the wavelength range of 350-700 nm. A pulsed xenon flash lamp (L7684, Hamamatsu Photonics, Bridgewater, N.J.) was used as the light source. A six-around-one fiber optic probe configuration (diameter=200 μm; NA=0.22) was used where the central fiber illuminated the sample and six surrounding fibers collected the diffusely reflected light. A source-detector separation of 300 μm was employed. The light collected by the fiber optic probe was focused on the entrance slit of a spectrograph (SP-150, Princeton Instruments, Trenton, N.J.) that dispersed the light onto a 12-bit CCD (CoolSnap, Photometrics, Tucson, Ariz.).

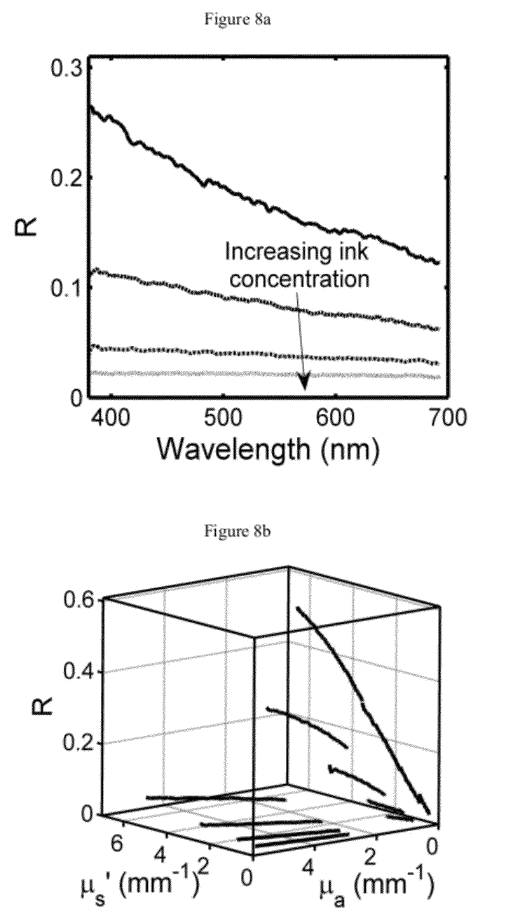

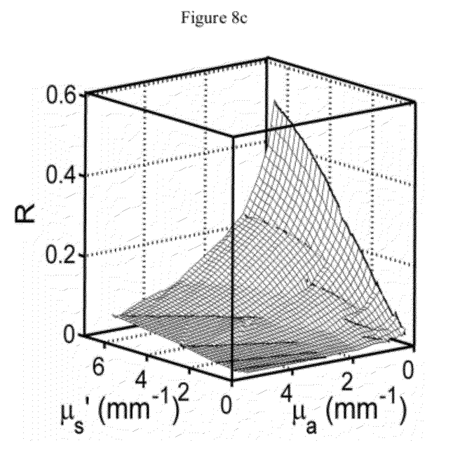

A LUT was generated by measuring the functional form of the reflectance using tissue phantoms with known optical properties (a calibration set). These phantoms were fabricated using polystyrene microspheres (diameter=1 μm; Polysciences, Warrington, Pa.) and India ink (Salis International, Golden, Colo.) dissolved in water to simulate scattering and absorption, respectively. Mie theory was used to calculate μₛ′ of the tissue phantoms, and μₐ of a stock India ink solution was measured using a spectrophotometer (DU 720, Beckman Coulter, Fullerton, Calif.). We created a matrix (4×6) of 24 tissue phantoms with varying scattering (μₛ′(λ)=0.22-7.1 mm⁻¹) and absorption parameters (μₐ(λ)=0-5.33 mm⁻¹). The probe was placed in contact with the surface of the tissue phantoms and spectrally resolved diffuse reflectance spectra from the phantoms were recorded (FIG. 8a).

The mapping of the spectrally resolved diffuse reflectance (R) on to a unique LUT is shown in FIG. 8. The spectral dependence of R results from the wavelength dependent optical properties, μₛ′(λ) and μₐ(λ). Because μₛ′(λ) and μₐ(λ) are known for the tissue phantoms, R can be mapped from wavelength space to the two dimensional optical property space. This mapping creates a sparse matrix (FIG. 8b) for R. This sparse matrix was then interpolated to a grid of uniformly spaced data points of μₛ′ and μₐ to obtain a LUT for diffuse reflectance (FIG. 8c). The limits of the LUT correspond to the range of μₛ′ and μₐ over which diffuse reflectance spectra were recorded.

To validate the performance of the LUT, a separate matrix of tissue phantoms (a validation set) was created. Because the LUT is generated with experimental data, a validation set with the same absorber as the calibration set might influence the inverse model while fitting the diffuse reflectance spectra. Therefore, tissue phantoms were used with different chromophores to create the LUT and validate the accuracy of the inverse model. Tissue phantoms for the validation set were fabricated using polystyrene microspheres and hemoglobin (Sigma, St. Louis, Mo.) as the absorber. A matrix (3×6) of 18 different tissue phantoms was then created for the validation set by varying the values of μₛ′(λ₀) and [Hb].

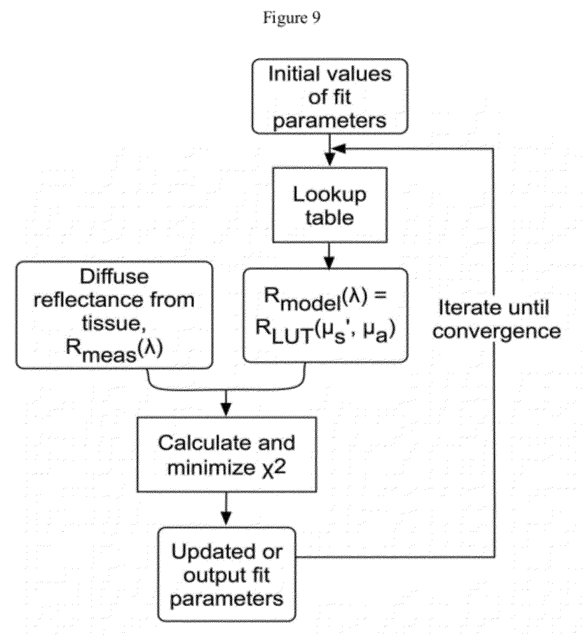

To fit our diffuse reflectance spectra and extract the optical properties, a nonlinear optimization fitting routine was implemented as described in FIG. 9. We constrained the reduced scattering coefficient to the form μₛ′(λ)=μₛ′(λ₀).(λ/λ₀)^{-B} where λ₀=630 nm. The absorption in the visible range was assumed to be due to oxy- and deoxy-hemoglobin. The absorption coefficient was calculated using the absorption cross-sections (σ_{Hb} and σ_{HbO2}) of these chromophores as μₐ(λ)=[Hb] (ασ_{HbO2}+(1−α)σ_{Hb}), where α is the oxygen saturation and [Hb] is the total hemoglobin concentration. Depending on the type of tissue sampled and the wavelength range of interest, the expression for μₐ(λ) can be modified to include the absorption cross-sections of other absorbing chromophores.

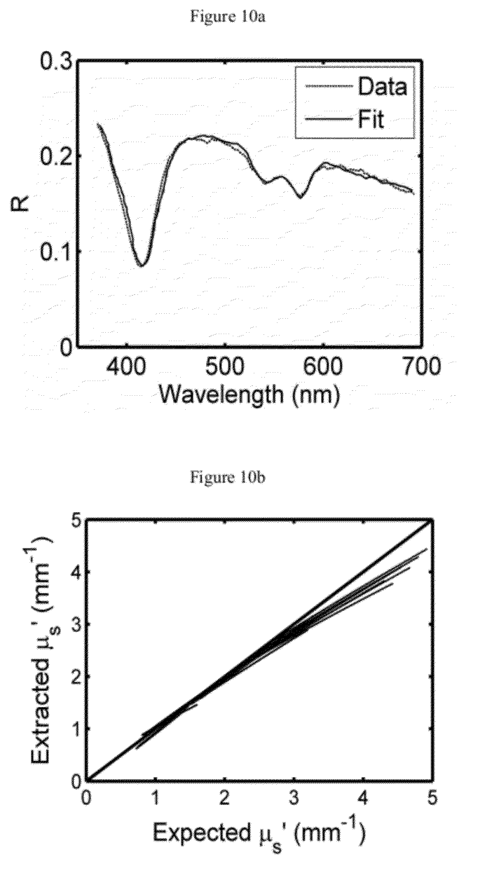

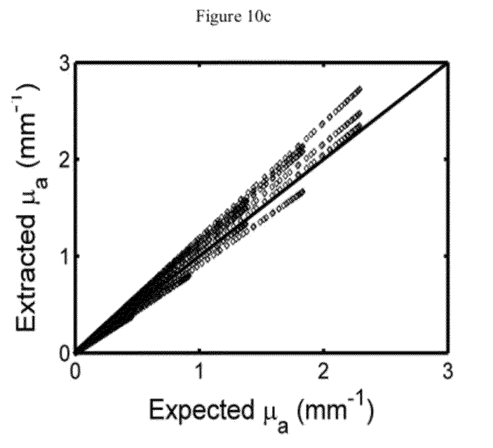

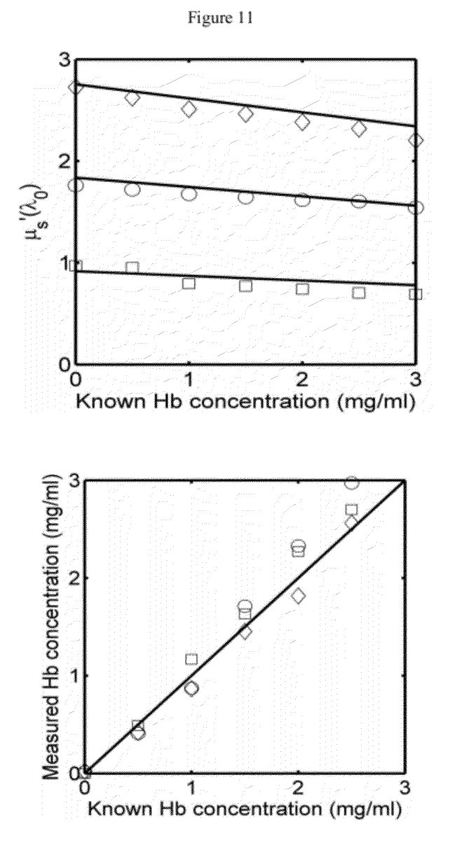

The diffuse reflectance spectrum and corresponding fit from a sample validation phantom is shown in FIG. 10a demonstrating excellent agreement between the model and the experimental data. Scatter plots of the extracted versus expected values of μₛ′(λ) (FIG. 10b) and μₐ(λ) (FIG. 10c) demonstrate a high degree of accuracy in extracting optical properties. The LUT inverse model estimated the reduced scattering and absorption coefficients over a wide range (μₛ′(λ)=0.72-4.91 mm⁻¹ and μₐ(λ)=0-2.29 mm⁻¹) with mean RMS percent errors of 5.9% and 11.6%, respectively. These scatter plots show the extracted μₛ′(λ) and μₐ(λ) for the entire validation set. FIG. 11 illustrates extracted physical parameters for each tissue phantom of the validation set, demonstrating good agreement between the expected and the measured values of μₛ′(λ₀) and [Hb]. In all phantoms, the oxygen saturation was held a constant in the experiment and the fit did not vary by more than 2%. The average errors in estimating μₛ′(λ₀) and [Hb] over the entire validation set were 4.9% and 9.6%, respectively.

The performance of the LUT-based model was compared to a diffusion approximation (DA)-based model described by Farrell et al. (Table 1). At a source-detector separation of 300 μm, the LUT model represents a significant improvement in the recovery of the physical parameters over the DA model. The LUT model improved the accuracy in recovering scattering at 630 nm (μₛ′(λ₀) and hemoglobin concentration ([Hb]) by factors of 2.5 and 5.5, respectively.

In addition, a fundamental limitation of analytical solutions such as the diffusion approximation is that scattering should dominate absorption by at least a factor of 10 (μₛ′>10μₐ). This implies that the albedo must be greater than 0.9 for the diffusion approximation to be valid. This condition is usually violated in the visible region of light, especially the Soret absorption band (400-430 nm) of hemoglobin. However, at the lowest value of albedo seen in the validation set (0.35), the LUT model was able to estimate the μₛ′(λ₀) and [Hb] with errors of 6.2% and 8% respectively.

This analysis indicates that the errors for the LUT-based model are close to 10% for determining both scattering and absorption. A certain component of the error in the inverse model could arise from the uncertainty in optical properties of the calibration set used to generate the LUT. For example, the scattering coefficient of calibration set phantoms was calculated using Mie theory and the bead concentration reported by the manufacturer. The experimental error in this concentration is on the order of a few percent and will propagate through our final inverse solution. Other sources of error include knowledge of bead size, presence of electronic noise is the collected reflectance, knowledge dye extinction coefficient, and fabrication of phantoms. While these errors primarily contribute to the overall accuracy of the solution, they should not affect the precision, which is important when comparing tissue pathologies for disease diagnosis. Minimizing these errors could lead to a significant improvement in the accuracy of the LUT-based model.

### Example 3

### Non-Contact Diffuse Optical Spectroscopy Device

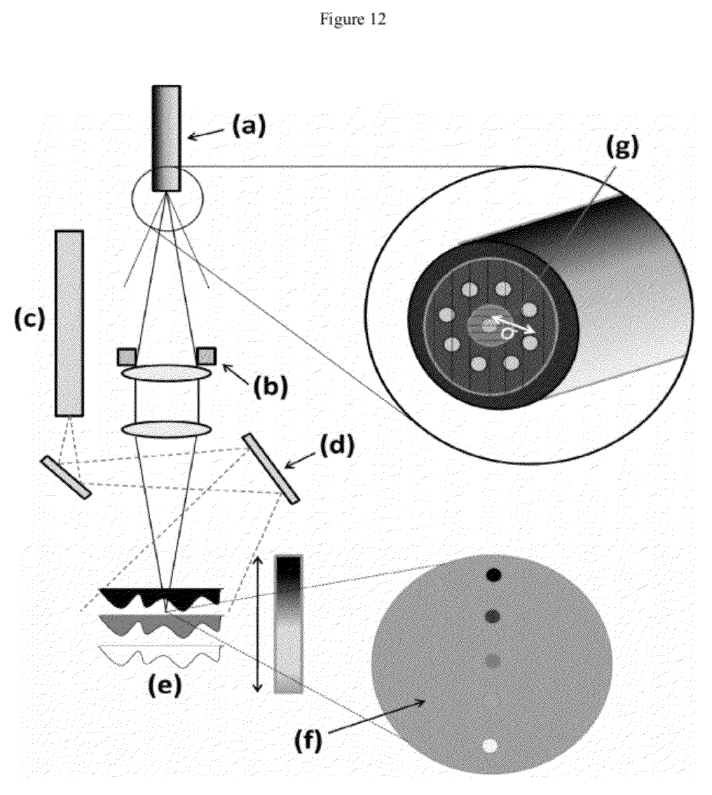

FIG. 12 illustrates the design of the handheld noncontact DOS system. A 6.35 mm diameter steel reflectance probe ferrule used for tissue contact reflectance measurements contains a group of 200 μm (0.22 NA) diameter optical fibers (Fibertech Optica, Kitchener Ontario, Canada). The source and collection fibers are separated by 740 μm, which will be referred to as the source-detector separation (a). On the ferrule tip, a cross polarizer (Edmund Optics, Barrington, N.J.) ensured that the light emitted from the source fiber was orthogonally polarized with respect to the light entering the collection fibers for all visible wavelengths. The ferrule tip was imaged onto the sample surface for a 1-to-1 magnification using two 1″ diameter achromatic 100 mm lenses (Thorlabs, Newton, N.J.) in infinite conjugate formation in order to maintain the a and probe ferrule geometry. The lenses and probe were mechanically stabilized with a 30 mm cage assembly. A tungsten-halogen lamp (LS-1 Ocean Optics, Dunedin, Fla.) was used to provide white light illumination, while a spectrometer (USB4000 Ocean Optics) collected reflectance light for post-processing.

Because the depth of focus is limited to approximately 1-4 mm, a custom auto-focusing scheme was employed to ensure that the sample surface remained within the image plane. Proper image condition is confirmed by insuring that the collected light intensity is brought to a local minimum as there should be no overlap between the illumination and collection cones at the sample surface. An attached camera is used as part of the auto-focusing mechanism and to acquire a digital picture of the measurement area for reference (FIG. 12).

The non-contact probe performance was validated using tissue simulating liquid phantoms with 1 μm diameter polystyrene beads (Polysciences, Warrington, Pa.) for scattering and ferrous stabilized hemoglobin for absorption (Sigma-Aldrich, St. Louis, Mo.). In this validation, an array of phantoms were created that contained incremental levels of reduced scattering (μₛ′) and absorption (μₐ). To test the performance of the non-contact optical probe, DOS measurements were acquired from all phantoms with the non-contact probe and the reflectance spectra were fit for the optical and physical properties of μₛ′ and hemoglobin concentration ([HbO2]) using an iterative inverse algorithm utilizing a look-up table (LUT) method.

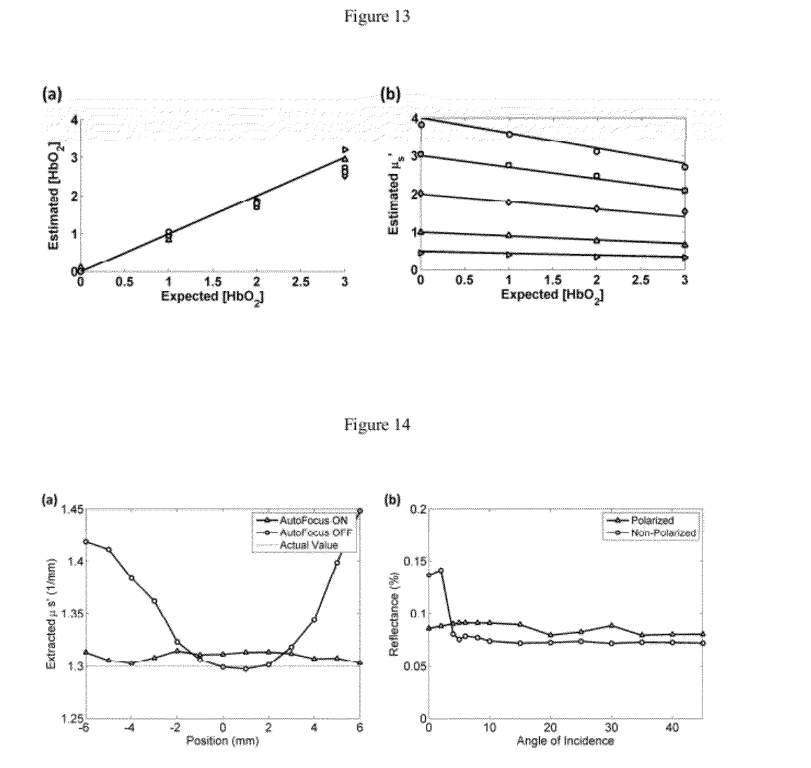

To test the non-contact probe performance, 21 validation phantoms were used with reduced scattering coefficients of 0.5, 1, 2, 3, and 4 mm⁻¹, and hemoglobin concentrations of 0 to 3 mg/ml in 1 mg/ml increments. The non-contact probe was aligned at normal incidence to the phantom surface. From the reflectance spectra, the reduced scattering and hemoglobin concentration properties were extracted using the LUT method. The non-contact probe was validated for μₛ′(λₒ) (where λₒ=630 nm) and [HbO2] with errors of 3.46% and 8.62% for reduced scattering and absorption respectively, which is comparable to those obtained from contact probes. The extracted μₛ′(λₒ) yielded errors of 7.26%, 2.60%, 3.00%, 1.63%, and 2.81% for 0.5 mm⁻¹ 1 mm⁻¹, 2 mm⁻¹ and 3 mm⁻¹ and 4 mm⁻¹ μₛ′ phantoms respectively across all levels of hemoglobin absorption. (FIG. 13).

The auto-focus function was introduced as a means of keeping the sample surface within the image plane of the non-contact probe. To achieve this, a CCD camera (1800 endoscope LLC, Bradenton, Fla.), integrated into the cage design, images an area of the sample surface containing the illumination spot in the center. The height of the illumination spot in the camera image (denoted by the pixel row) is proportional to the axial position of the sample within the optical axis of the non-contact probe (FIG. 12). This relationship is used to direct a servo motor (Thorlabs, Newton, N.J.) in controlling the axial position of the focusing lens and therefore, the axial position of the beam waist. To determine the depth of field, the auto-focus function was turned off while a z-stage axially translated a scattering phantom (μₛ′=1.3 mm⁻¹). Each collected spectra was fitted for μₛ′ using the LUT fitting algorithm. In this manner, the depth of field could be considered the axial distance within which the extracted optical properties achieve errors of less than 10%. The experiment was repeated with the auto-focus function on. Using this method, the accuracy and precision of the auto-focusing scheme was analyzed. Auto-focus validation showed a depth-of-field of approximately 4 mm while the auto-focus was off (FIG. 14a). However, with the auto-focus feature turned on, the extracted μₛ′ values of the liquid phantom were kept to within 10% error for the full travel of the translational motor (>1.2 cm).

To verify the effectiveness of cross-polarization in mitigating specular reflections on our measurements, thin film polarizers were used in contact with the source and detector fibers so that their transmission axes were mutually perpendicular. To determine the influence of specular reflection on the reflectance signal, a sample of PDMS with titanium dioxide scattering agent (μₛ′=1.4 mm⁻¹) was placed on a rotation stage. This sample was rotated from 0° to 45° with respect to the illumination beam in 2° (from 0° to 10°) and 5° (10° to 45°) increments. The reflectance spectra were collected for all angles of illumination/collection. This experiment was performed with and without cross-polarization for comparative analysis. Without cross polarization, specular reflection can be seen over any incidence angle under 5 degrees. However with cross polarization, there is no noticeable contribution of specular reflection to the reflectance signal throughout the range of incidence angles tested.

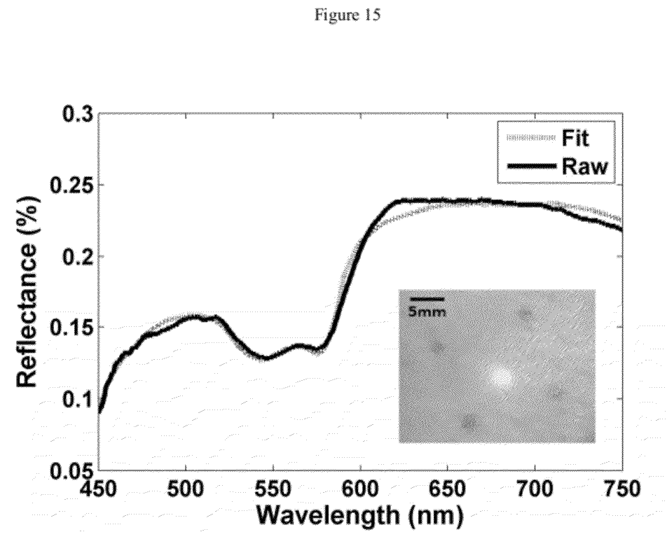

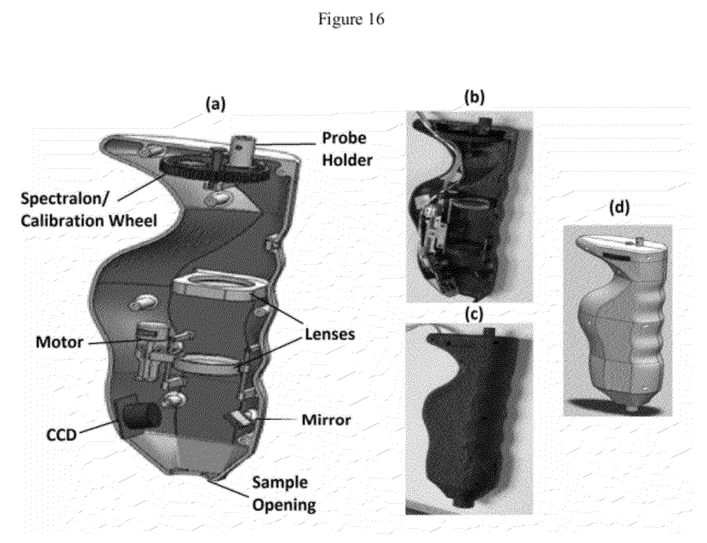

An in-vivo measurement with the non-contact point probe was made on a subject's hand as shown in FIG. 15. As expected, light absorption within the Q-bands (525-590 nm) characteristic of hemoglobin was visible. The LUT fit of the reflectance spectrum led to the extraction of reduced scattering, hemoglobin concentration, oxygen saturation and mean vessel diameter which resulted in a μₛ′(λₒ) value of 1.32 mm⁻¹, a [HbO2] value of 5.57 mg/ml, oxygen saturation value of 0.622, and mean blood vessel diameter of 30 μm. Ergonomic adaptations of this non-contact concept have been designed in our lab, demonstrating the clinical potential of this device (FIG. 16).

Most of the aforementioned experiments involve liquid phantoms which have smooth surfaces; however, in a clinical setting, specular reflections originate from the diffusely reflective surfaces characteristic of epithelium. Therefore, no angles of incidence exist that would effectively reduce these reflections under those conditions. Specular reflections confound the DOS spectra in a way that is not constant from site to site. The degree of surface roughness will determine the amount of specularly reflected light collected; therefore, it is favorable to eliminate or effectively reduce this signal. This is why polarization-based solutions of reducing specular reflection were used which relies on the concept that polarized light is depolarized by tissues to a degree that is proportionate to distribution of refractive indices in the sample. Through this depolarization effect, diffusely reflected light due to scattering is collected, while specular reflections are rejected. Since cross polarization rejects not only specular reflection but also single scattering from the outermost epithelium, collected light becomes biased towards photons that have encountered more scattering events and traveled deeper depths. As a result our reflectance measurements become more sensitive to basal and dermal layer absorption and collagen scattering. Without cross polarization, reflectance signal from multiple scattering photons are partially buried underneath shallow penetrating photons that are less sensitive to blood absorption. Other designs rely on an index matching medium between the probe and tissue surface. In the design presented here, the effectiveness and robust nature of cross polarization is combined with the design simplicity of single-axis reflection probing.

The validation of the non-contact probe as performed in this study was used solely to show that removing the bare probe from the tissue would not adversely affect performance relative to the original probe. As it relates to the ultimate goal of tissue reflectance measurements, validation should include scatterers of 0.1 to 5 μm in size to account for the relevant distribution of scattering cross sections in tissue (nuclei, mitochondria, cell membrane, collagen, etc).

A novel non-contact spectral reflectance point probe has been developed and validated that eliminates probe pressure effects on spectral reflectance by eliminating probe pressure with a non-contact probe design. This non-contact addition validates very well for samples with biologically relevant scattering and absorption. Problems that non-contact probing introduces include surface contour unpredictability and specular reflections which are relieved through the use of an auto-focusing technique and cross polarization. Solutions such as these address patient movement and tissue contours that can easily bring the tissue surface out of the focal region of the non-contact probe.

### Example 4

### Non-Contact Raman Spectroscopy Device

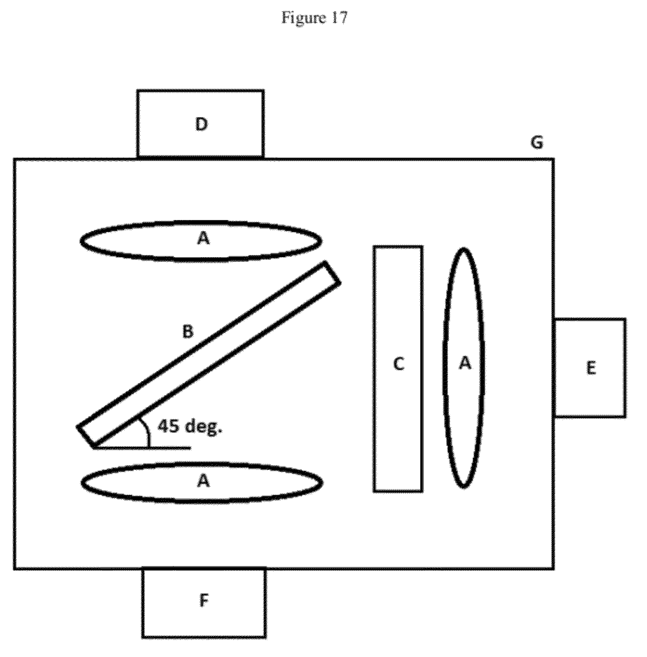

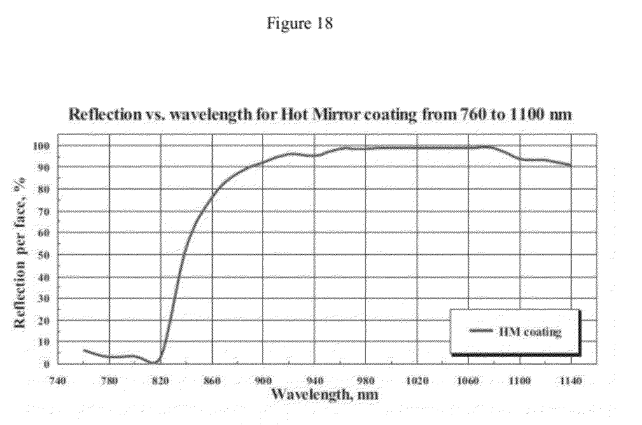

Laboratory benchmark tests were performed on the optical components that make up the system. This benchtop laboratory system (FIG. 17) required a source excitation laser of 808 nm coupled into a low OH fused silica optical fiber and directed towards the doublet infrared (IR) achromatic lens system. Next the excitation light passes through the collimated region of the lenses where it will encounter the hot dichroic mirror TYDEX BK7 Dichroic Mirror (FIG. 18). This hot dichroic mirror is an important component of the Raman setup, because its transmission and reflection efficiency may largely determine the overall Raman system collection efficiency. Since, the integration time and adequate signal-to-noise ratio of the system hinges on the collection efficiency the hot mirror should perform within its specified optical parameters. To address this possible issue transmission efficiency of the hot mirror was tested by sending an excitation 808 nm light towards the mirror while placing a collection fiber on a parallel optical path on the opposite side of the mirror. The test also requires a collection fiber on an orthogonal optical path to detect the reflected light intensity. After a suitable integration time the transmission intensity relative to the reflection intensity may be verified, hence verifying the optical cutoff threshold of the mirror. A similar procedure was followed for wavelengths above 850 nm to assess the performance of the mirror past the transition cut off wavelength.

The next step was to calibrate the distance between the source fiber and the achromatic IR lens system such that the excitation fibers optical geometry is mapped 1:1 to the desired imaging plane. To achieve the optimal focal length and lens setup one may utilize an infrared camera to detect the correct point size of the excitation beam on the imaging plane.

Following the optical component testing and lens focal length optimization process an optical cage was fabricated to prevent ambient light from reaching the detector.

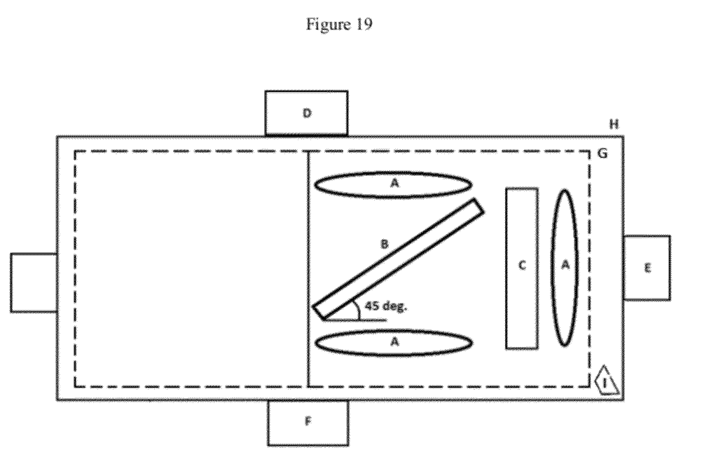

A handheld probe that will contain the Raman optical components (FIG. 19), also may be construbed. Such a system may include an automated internal revolving lens system. This system must allow for highly precise and repeatable alignments to enable accurate lens system positioning without the possibility of significant drift in measurements over several usage cycles. A mechanical system with a lock-in-place mechanism to hold the lens system fixed may be required.

Following the revolving system development a linear translational mechanism may be designed and implemented that will allow for quick autofocus functionality. Since the Raman system utilizes IR light for its spectroscopic analysis one must incorporate an IR sensitive camera to provide visual feedback for the beam point and autofocus algorithm.

Phase III—Integration

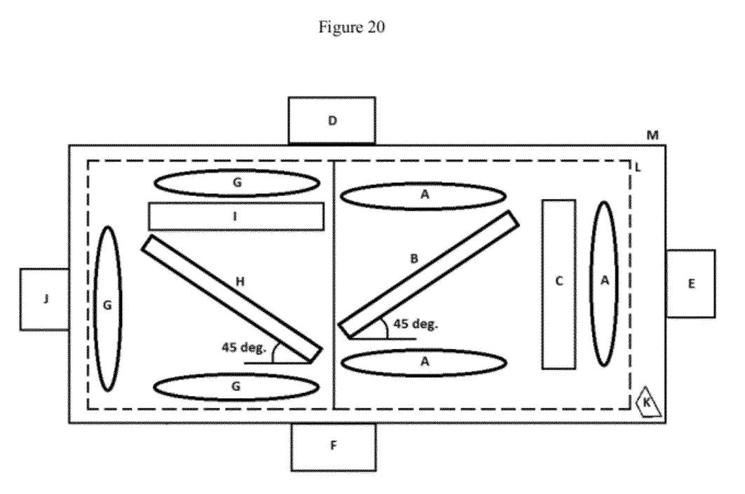

The final development phase of the skin cancer probe may be the integration of the previous diffuse reflectance and fluorescence optical components (FIG. 20). Since the mechanical apparatus and probe structure will be the same as before, little should need to be tweaked in order to integrate the new visual spectrum components into the handheld system.

A skin cancer detection system that can diagnose malignancy in a timely and more specific fashion is essential to the treatment of this prevalent disease. Many dermatologists are interested in technology that facilitates diagnosis in a sensitive and specific manner. This would lessen the cost burden of excision procedures on patients and decrease the time gap between positive diagnosis and treatment. A handheld device that incorporates Raman, reflectance, and fluorescence spectroscopies will provide a more detailed spectroscopic analysis of a given tissue morphology and achieve threshold values for sensitivity and specificity that exceed an unaided dermatologist's diagnostic capability.

### Example 5

### Device with Multiple Spectroscopic Modalities

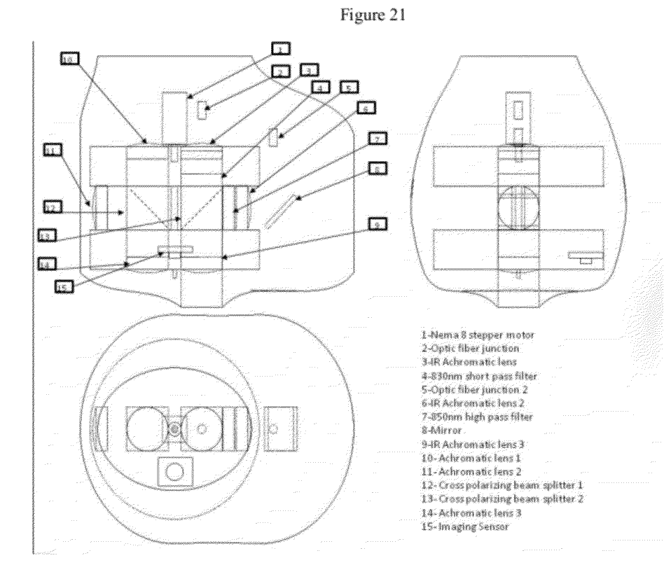

FIG. 21 is a schematic outlining an example of a suitable optical configuration for integration of multiple spectroscopic modalities into a single handheld clinical probe. The design utilizes a revolving assembly, similar to the revolving nosepiece of a microscope. This revolving assembly allows for orientation of the polarizing beam splitter and related lens system to center in the optical axis with a high degree of reproducibility.

Additionally, the probe incorporates a high resolution camera in the revolving assembly for tracking and centering a target lesion. An operator of the probe can begin a spectroscopic analysis of a given lesion by pressing a trigger switch which initiates the stepper motor. The stepper motor drives the rotation of the revolving assembly and receives feedback from various detectors for optimal alignment. Additional stabilization methods will hold the assembly fixed in place when centered over the lesion.

The basic path a photon packet would take through the system is as follows. The photons would enter the system from the optic fiber junction (2) and be directed towards the adjacent plano-convex lens. Next, the light passes through the collimated region and encounters a polarizing beam splitter, which allows only P polarized light to transmit towards the sample to be measured. Before this light reaches the sample, it impinges upon an additional plano-convex lens, which focuses the light to a point on the sample. The diffuse light exiting from the sample will become non-polarized and travel back along the aforementioned path. When this light meets the beam splitter the S component of the diffuse light will be reflected towards the detector fiber bundle. The reflected light will be focused to a point from the final plano-convex lens in the system and will be reflected once more by a mirror (8) to a collection fiber (5).

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Therefore, the present invention is well adapted to attain the ends and advantages mentioned as well as those that are inherent therein. While numerous changes may be made by those skilled in the art, such changes are encompassed within the spirit of this invention as illustrated, in part, by the appended claims.

What is claimed is:

1. A system comprising an optical fiber switch connected to a light source and an optical fiber probe, the optical fiber probe comprising a first optical fiber connected to the optical fiber switch and a second optical fiber connected to a spectrophotometer.

2. The system of claim 1 further comprising a tissue disposed adjacent to the optical fiber probe.

3. The system of claim 1 wherein the first optical fiber is a first plurality of optical fibers and the second optical fiber is a second plurality of optical fibers.

4. The system of claim 1 wherein the second optical fiber is a plurality of optical fibers disposed around the outer diameter of the first optical fiber.

5. The system of claim 1 wherein the second optical fiber is a plurality of six optical fibers disposed around the outer diameter of the first optical fiber.

6. The system of claim 1 wherein the optical fiber probe is according to FIG. 21.

7. The system of claim 1 wherein the light source is a laser light, a white light, or both.

8. The system of claim 1 further comprising a software interface connected to the spectrophotometer, wherein the software interface is capable of displaying a tissue parameter derived from a spectra generated by the spectrophotometer.

9. The system of claim 8 wherein the software interface comprises a lookup-table based algorithm.

10. The system of claim 8 wherein the software interface comprises a lookup-table based algorithm, the lookup-table based algorithm comprising:
generating a look-up table by measuring the functional form of a reflectance measured by the spectrophotometer using one or more calibration standards with known optical properties; and
implementing an iterative fitting routine based on the lookup-table.

11. The system of claim 8 wherein the lookup-table based algorithm further comprises using a nonlinear optimization fitting routine to fit the spectra.

12. The system of claim 11 wherein the nonlinear optimization fitting routine comprises:
constraining a reduced scattering coefficient to the form μₛ′(λ)=ₛ′(λ₀).(λ/λ₀))^{-B} where λ₀=630 nm; and
calculating an absorption coefficient using the absorption cross-sections σ_{Hb} and σ_{HbO2} as μₛ(λ)=[Hb]*(ασ_{HbO2}+(1−α)σ_{Hb})+X, where α is the oxygen saturation of the tissue, Hb is the total hemoglobin concentration of the tissue, and X is adsorption coefficient of a chromophore.

13. A method for assessing a tissue comprising:
providing an optical fiber switch connected to a light source and an optical fiber probe, the optical fiber probe comprising a first optical fiber connected to the optical fiber switch and a second optical fiber connected to a spectrophotometer;
providing a tissue disposed adjacent to the optical fiber probe;
allowing light emitted from the first optical fiber into the tissue; and
collecting the light reemitted from the tissue with the second optical fiber.

14. The method of claim 13 further comprising providing a software interface connected to the spectrophotometer, wherein the software interface is capable of displaying a tissue parameter derived from a spectra generated by the spectrophotometer.

15. The method of claim 13 further comprising generating a spectra of the light reemitted from the tissue with a spectrophotometer.

16. The method of claim 13 further comprising utilizing a look-up table based algorithm to determine one or more tissue parameters.

17. The method of claim 13 wherein the first optical fiber is a first plurality of optical fibers and the second optical fiber is a second plurality of optical fibers.

18. The method of claim 13 wherein the second optical fiber is a plurality of optical fibers disposed around the outer diameter of the first optical fiber.

19. The method of claim 13 wherein the second optical fiber is a plurality of six optical fibers disposed around the outer diameter of the first optical fiber.

20. The method of claim 13 wherein the optical fiber probe is according to FIG. 21.

21. The method of claim 13 wherein the light source is a laser light, a white light, or both.

22. The method of claim 13 wherein allowing light emitted from the first optical fiber into the tissue comprises: emitting laser light having a wavelength of about 337 nm; emitting laser light having a wavelength of about 450 nm; and emitting white light.

23. The method of claim 13 wherein the tissue comprises an epithelial lesion.

24. The method of claim 16 wherein utilizing a lookup-table based algorithm comprises:
generating a look-up table by measuring the functional form of a reflectance measured by the spectrophotometer using one or more calibration standards with known optical properties; and
implementing an iterative fitting routine based on the lookup-table.

25. The method of claim 16 wherein the lookup-table based algorithm further comprises the step of using a nonlinear optimization fitting routine to fit the spectra.

26. The method of claim 16 wherein the lookup-table based algorithm comprises the steps of:
generating a look-up table by measuring the functional form of a reflectance measured by the spectrophotometer using one or more calibration standards with known optical properties; and
implementing an iterative fitting routine based on the lookup-table.

27. The method of claim 16 further comprising imaging a distal end of the optical fiber probe onto a tissue sample surface; and obtaining an image of the tissue sample using a C, wherein the image is obtained without placing the probe and tissue sample surface in direct contact.

28. A fiber-optic probe comprising: a collection fiber, an illumination fiber and an optical device that images the illumination fiber and the collection fiber onto a surface of a tissue sample.

29. The fiber-optic probe claim 28 wherein the probe comprises a cross-polarizer.

30. The fiber-optic probe claim 28 wherein a plurality of illumination fibers are disposed around the outer diameter of one or more collection fibers.

31. The fiber-optic probe claim 28 wherein the first optical fiber is a first plurality of optical fibers and the second optical fiber is a second plurality of optical fibers.

32. The fiber-optic probe claim 28 wherein the second optical fiber is a plurality of optical fibers disposed around the outer diameter of the first optical fiber.

33. The fiber-optic probe claim 28 wherein the second optical fiber is a plurality of six optical fibers disposed around the outer diameter of the first optical fiber.

34. The fiber-optic probe claim 28 wherein the optical fiber probe is according to FIG. 21.

35. The fiber-optic probe claim 28 further comprising a filter.

36. The fiber-optic probe claim 28 further comprising an autofocus mechanism.

37. The fiber-optic probe claim 28 further comprising a CCD device.

38. A non-contact handheld device capable of capturing digital images of skin lesions while also measuring Raman, reflectance, and/or fluorescence spectra for the diagnosis of skin cancer.

39. The device of claim 38 comprising a fiber-optic probe that comprises a collection fiber, an illumination fiber and an optical device that images the illumination fiber and the collection fiber onto a surface of a tissue sample.

40. The device of claim 39 wherein the probe comprises a cross-polarizer.

41. The device of claim 39 wherein a plurality of illumination fibers are disposed around the outer diameter of one or more collection fibers.

42. The device of claim 39 wherein the first optical fiber is a first plurality of optical fibers and the second optical fiber is a second plurality of optical fibers.

43. The device of claim 39 wherein the second optical fiber is a plurality of optical fibers disposed around the outer diameter of the first optical fiber.

44. The device of claim 39 wherein the optical fiber probe is according to FIG. 21.
